(19) United States
(12) Patent Application Publication
(10) Pub. No.: US 2016/0102274 A1
(43) Pub. Date: Apr. 14, 2016

(54) DETERGENT BUILDER AND DISPERSANT SYNERGY IN CALCIUM CARBONATE SCALE PREVENTION

(71) Applicant: Rivertop Renewables, Inc., Missoula, MT (US)

(72) Inventors: Tyler Smith, Missoula, MT (US); Erik Johnston, Missoula, MT (US); Brian Furey, Missoula, MT (US)

(21) Appl. No.: 14/876,148

(22) Filed: Oct. 6, 2015

Related U.S. Application Data
(60) Provisional application No. 62/061,281, filed on Oct. 8, 2014.

(51) Int. Cl. C11D 3/20; C11D 3/37; C11D 3/04; C11D 3/22

(52) U.S. Cl. CPC C11D 3/2086; C11D 3/222; C11D 3/3719; C11D 3/046; C11D 3/048

(57) ABSTRACT

Cleaning compositions are provided. The cleaning compositions can include a builder and a dispersant. The cleaning compositions can include one or more additional components. The cleaning compositions can be used in cleaning applications such as automated dishwashing.

### CROSS-REFERENCE TO RELATED APPLICATIONS

This application claims priority to U.S. Provisional Patent Application No. 62/061,281, filed Oct. 8, 2014, the entire contents of which are hereby incorporated by reference.

### TECHNICAL FIELD

This disclosure relates to cleaning compositions for use in a variety of applications such as, but not limited to, warewashing applications. The cleaning compositions include one or more builder and one or more dispersant.

### BACKGROUND

Detergents are cleaning mixtures composed primarily of surfactants, builders, dispersants, bleaching-agents, enzymes, and fillers. The builder can be a single substance or a mixture of substances and commonly serves multiple functions. An important builder function is the sequestration of metal cations, typically calcium and magnesium cations, found in hard water. When calcium or magnesium salts precipitate, the crystals may attach to the surface being cleaned and cause undesirable effects. For example, calcium carbonate precipitation on the surface of a ware can cause spotting, negatively impacting the aesthetic appearance of the ware, giving an unclean look. In the food and beverage industry, the calcium carbonate residue can affect the acidity levels of foods. Precipitation may also cause glass corrosion characterized by the appearance of an iridescent film with rainbow hues that progressively becomes cloudier with additional washing. The builders act as water softening agents and prevent the formation of water insoluble salts between cations and anion components in the wash solution, alleviating undesirable effects. Other functions of builders include removing soils, increasing alkalinity of detergent solutions, deflocculating surfactant micelles, and inhibiting corrosion.

Industrial, institutional, and consumer alkaline detergents have traditionally contained builders that include phosphates, nitrilotriacetic acid (NTA) and ethylenediaminetetraacetic acid (EDTA). However, environmental regulations continue to restrict the use of phosphorus compounds, NTA, and EDTA in applications where the material is discharged into surface water. These regulations have created a need for environmentally acceptable materials for use in cleaning compositions. The present disclosure is directed to such an environmentally acceptable cleaning composition.

### SUMMARY

In one aspect, disclosed is a cleaning composition comprising, by weight, about 1% to about 45% a builder and about 0.1% to about 10% a dispersant.

The compositions, methods, and processes are further described herein.

### BRIEF DESCRIPTION OF THE DRAWINGS

FIG. 1 is a graph depicting the spotting and filming performance of cleaning compositions comprising Acusol 445 and Riose™.

FIG. 2 is a graph depicting the spotting and filming performance of cleaning compositions comprising carboxymethyl inulin and Riose™.

FIG. 3 is a graph depicting the spotting and filming performance of cleaning compositions comprising polyaspartic acid and Riose™.

FIG. 4 is a graph depicting the spotting and filming performance of cleaning compositions comprising Acusol 445 and MGDA, sodium citrate, or Riose™.

FIG. 5 is a graph depicting the spotting and filming performance of cleaning compositions comprising carboxymethyl inulin and MGDA, sodium citrate, or Riose™.

FIG. 6 is a graph depicting the spotting and filming performance of cleaning compositions comprising carboxymethyl inulin and Riose™.

FIG. 7 is a graph depicting the spotting and filming performance of cleaning compositions comprising polyaspartic acid and MGDA, sodium citrate, or Riose™.

### DETAILED DESCRIPTION

The present disclosure relates to cleaning compositions, methods for preparing the cleaning compositions, and methods for using the cleaning compositions. The disclosed cleaning compositions include at least one builder and at least one dispersant.

The combination of the builders and dispersants of the present disclosure results in a cleaning composition in which the individual components have the ability to chemically interact with the particulate matter it is removing from the surface in a manner that results in a better than expected improvement in cleaning capability. Accordingly, the combination of specific builders and dispersants in the cleaning composition leads to compositions that are unexpectedly superior cleaning compositions. The combination of a builder comprising at least one salt of a hydroxycarboxylic acid selected from hydroxymonocarboxylic acid or hydroxydicarboxylic acid and at least one oxoacid anion salt and a polymeric dispersant, such as polyaspartic acid, carboxymethyl inulin or a homopolymer of acrylic acid with molecular weight of about 4500 g/mol results in a cleaning composition with synergistic improvements in cleaning capabilities over what would be expected if the effects of the builder and dispersant on the cleaning composition were only additive. In particular, these combinations result in compositions that display up to a 59% synergistic improvement in spotting performance and up to a 48% synergistic improvement in filming performance over what would be expected if the effects of the builder and dispersant on the cleaning composition were only additive. The combinations of these specific dispersants with other builders do not demonstrate any synergistic improvement in cleaning capability.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, the term “hydroxycarboxylic acid salt” can generally be considered the salt of any oxidation derivative of carbohydrates or other polyols, and should be construed to primarily include hydrocarboxylic salts such as hydroxymonocarboxylic acid salts and hydroxydicarboxylic acid salts. Mixtures of hydroxycarboxylic acid salts may be conveniently prepared by the oxidation of carbohydrate or other polyol compounds. Oxidation of carbohydrate compounds can be carried out in a variety of known methods, including oxidation with nitric acid, oxidation with nitrogen dioxide, oxidation with air or oxygen over metal catalysts, and oxidation with tetraalkylnitroxyl radical compounds such as TEMPO. For example, a method for oxidation of carbohydrates is described in U.S. Pat. No. 7,692,041, the entire disclosure of which is hereby incorporated by reference in its entirety.

As used herein, the term “oxoacid anion salt” is defined as any water soluble salt form of an acid containing at least one oxygen atom. The oxoacid anion salt may include, but is not limited to salts of borate, aluminate, stannate, germanate, molybdate, antimonate and combinations thereof.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. THE CLEANING COMPOSITION

Disclosed is a cleaning composition. The cleaning composition includes at least one builder and at least one dispersant. The cleaning composition may also include one or more additional components. The builder forms stable, water soluble complexes with metal ions such as calcium and magnesium. The ability of the builder to form these chemical interactions aids in the cleaning and descaling process by removing and preventing undesired metal salts from adhering to the surface of the article being cleaned. The dispersant improves the separation of particles and prevents settling or clumping. The dispersant acts to disperse oils, soils, food products and wastes, and other physically hard to remove substances from various surfaces in the cleaning process.

The combination of a suitable builder and a suitable dispersant in a cleaning composition may be useful in the prevention of calcium carbonate scale for the purpose of boosting the effectiveness of a detergent. The cleaning compositions may have enhanced cleaning properties, namely improved spotting and filming performance. The combination of the builders and dispersants of the present disclosure results in a cleaning composition in which the individual components have the ability to chemically interact with the particulate matter it is removing from the surface in a manner that results in a better than expected improvement in cleaning capability.

These combinations result in compositions that display about 1% to about 75%, about 1% to about 70%, about 1% to about 65%, about 1% to about 60%, about 1% to about 55%, about 1% to about 50%, about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 10% to about 75%, about 10% to about 70%, about 10% to about 65%, about 10% to about 60%, about 10% to about 55%, about 10% to about 50%, about 10% to about 45%, about 10% to about 40%, about 10% to about 35%, about 10% to about 30%, about 10% to about 25%, about 10% to about 20%, about 10% to about 15%, about 20% to about 75%, about 20% to about 70%, about 20% to about 65%, about 20% to about 60%, about 20% to about 55%, about 20% to about 50%, about 20% to about 45%, about 20% to about 40%, about 20% to about 35%, about 20% to about 30%, about 20% to about 25%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 40% to about 75%, about 40% to about 70%, about 40% to about 65%, about 40% to about 60%, about 40% to about 55%, about 40% to about 50%, about 40% to about 45%, about 50% to about 75%, about 50% to about 70%, about 50% to about 65%, about 50% to about 60%, about 50% to about 55%, about 60% to about 75%, about 60% to about 70%, about 60% to about 65%, or about 70% to about 75% synergistic improvement in spotting performance over what would be expected if the effects of the builder and dispersant on the cleaning composition were only additive. These combinations result in compositions that display up to a 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75% synergistic improvement in spotting performance over what would be expected if the effects of the builder and dispersant on the cleaning composition were only additive.

These combinations result in compositions that display about 1% to about 75%, about 1% to about 70%, about 1% to about 65%, about 1% to about 60%, about 1% to about 55%, about 1% to about 50%, about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 10% to about 75%, about 10% to about 70%, about 10% to about 65%, about 10% to about 60%, about 10% to about 55%, about 10% to about 50%, about 10% to about 45%, about 10% to about 40%, about 10% to about 35%, about 10% to about 30%, about 10% to about 25%, about 10% to about 20%, about 10% to about 15%, about 20% to about 75%, about 20% to about 70%, about 20% to about 65%, about 20% to about 60%, about 20% to about 55%, about 20% to about 50%, about 20% to about 45%, about 20% to about 40%, about 20% to about 35%, about 20% to about 30%, about 20% to about 25%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 40% to about 75%, about 40% to about 70%, about 40% to about 65%, about 40% to about 60%, about 40% to about 55%, about 40% to about 50%, about 40% to about 45%, about 50% to about 75%, about 50% to about 70%, about 50% to about 65%, about 50% to about 60%, about 50% to about 55%, about 60% to about 75%, about 60% to about 70%, about 60% to about 65%, or about 70% to about 75% synergistic improvement in filming performance over what would be expected if the effects of the builder and dispersant on the cleaning composition were only additive. These combinations result in compositions that display up to a 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75% synergistic improvement in filming performance over what would be expected if the effects of the builder and dispersant on the cleaning composition were only additive. In particular, these combinations result in compositions that display up to a 59% synergistic improvement in spotting performance and up to a 48% synergistic improvement in filming performance over what would be expected if the effects of the builder and dispersant on the cleaning composition were only additive.

The cleaning composition may be useful in vehicle care applications and warewashing applications. For example, filming and spotting on glassware may be reduced when using employing the cleaning composition in an automatic dishwashing detergent.

The cleaning composition can be provided in the form of a solid, such as a tablet, stamped tablet, pressed tablet, granules or powder. The cleaning composition can also be provided in the form of a liquid, such as a pourable liquid or gel.

A. Properties of the Cleaning Composition

The cleaning, or scale inhibiting, ability of the cleaning compositions of the disclosure may be evaluated by Standard Test Methods for Deposition on Glassware During Mechanical Dishwashing (ASTM D3556). A series of soiled glasses and plates may be washed with the cleaning compositions in four wash cycles, each consisting of two rinse cycles, two wash cycles and a heated dry cycle. The washes may be achieved at a total water hardness of 300 ppm CaCO₃ (17.5 grains/gal; 2:1 Ca/Mg) and at a wash temperature of 120° F., in an automatic dishwasher. After the 4 washes are completed, all glasses are graded in an illuminating light box following the ASTM guidelines on a 1-5 filming and spotting scale (see Table 1).

TABLE 1
ASTM D3556 filming and spotting scale

| Rating | Spotting | Filming |
|---|---|---|
| 1 | No spots | None |
| 2 | Spots at random | Barely perceptible |
| 3 | About ¼ of surface covered | Slight |
| 4 | About ½ of surface covered | Moderate |
| 5 | Surface completely covered | Heavy |

The cleaning composition may have a spotting value of less than or equal to 5, less than or equal to 4.5, less than or equal to 4, less than or equal to 3.5, less than or equal to 3, less than or equal to 2.5, less than or equal to 2, less than or equal to 1.5, less than or equal to 1, or less than or equal to 0.5. The cleaning composition may have a spotting value of 5 or less, about 4.5 or less, about 4 or less, about 3.5 or less, about 3 or less, about 2.5 or less, about 2 or less, about 1.5 or less, about 1 or less, or about 0.5 or less. The cleaning composition may have a spotting value of less 5, less than 4.5, less than 4, less than 3.5, less than 3, less than 2.5, less than 2, less than 1.5, less than 1, or less than 0.5. The cleaning composition may have a spotting value of about 5, about 4.5, about 4, about 3.5, about 3, about 2.5, about 2, about 1.5, about 1, or about 0.5. The spotting value may be measured according to ASTM D3556.

The cleaning composition may have a spotting value at least 0.5 less, at least 1 less, at least 1.5 less, at least 2 less, at least 2.5 less, at least 3 less, at least 3.5 less, or at least 4.5 less than the spotting value of a cleaning composition comprising no dispersant. The cleaning composition may have a spotting value at least 0.5 less, at least 1 less, at least 1.5 less, at least 2 less, at least 2.5 less, at least 3 less, at least 3.5 less, or at least 4.5 less than the spotting value of a cleaning composition comprising no builder. The spotting value may be measured according to ASTM D3556.

The cleaning composition may have a filming value of less than or equal to 5, less than or equal to 4.5, less than or equal to 4, less than or equal to 3.5, less than or equal to 3, less than or equal to 2.5, less than or equal to 2, less than or equal to 1.5, less than or equal to 1, or less than or equal to 0.5. The cleaning composition may have a filming value of 5 or less, about 4.5 or less, about 4 or less, about 3.5 or less, about 3 or less, about 2.5 or less, about 2 or less, about 1.5 or less, about 1 or less, or about 0.5 or less. The cleaning composition may have a filming value of less 5, less than 4.5, less than 4, less than 3.5, less than 3, less than 2.5, less than 2, less than 1.5, less than 1, or less than 0.5. The cleaning composition may have a filming value of about 5, about 4.5, about 4, about 3.5, about 3, about 2.5, about 2, about 1.5, about 1, or about 0.5. The filming value may be measured according to ASTM D3556.

The cleaning composition may have a filming value at least 0.5 less, at least 1 less, at least 1.5 less, at least 2 less, at least 2.5 less, at least 3 less, at least 3.5 less, or at least 4.5 less than the filming value of a cleaning composition comprising no dispersant. The cleaning composition may have a filming value at least 0.5 less, at least 1 less, at least 1.5 less, at least 2 less, at least 2.5 less, at least 3 less, at least 3.5 less, or at least 4.5 less than the filming value of a cleaning composition comprising no builder. The filming value may be measured according to ASTM D3556.

The cleaning composition may have a spotting value at least 0.5 less, at least 1 less, at least 1.5 less, at least 2 less, at least 2.5 less, at least 3 less, at least 3.5 less, or at least 4.5 less than the spotting value of a cleaning composition comprising no builder, and have a spotting value of at least 0.5 less, at least 1 less, at least 1.5 less, at least 2 less, at least 2.5 less, at least 3 less, at least 3.5 less, at least 4.5 less than the spotting value of a cleaning composition comprising no dispersant. The spotting value may be measured according to ASTM D3556. The cleaning composition may have a filming value at least 0.5 less, at least 1 less, at least 1.5 less, at least 2 less, at least 2.5 less, at least 3 less, at least 3.5 less, or at least 4.5 less than the filming value of a cleaning composition comprising no builder, and have a spotting value of at least 0.5 less, at least 1 less, at least 1.5 less, at least 2 less, at least 2.5 less, at least 3 less, at least 3.5 less, at least 4.5 less than the filming value of a cleaning composition comprising no dispersant. The filming value may be measured according to ASTM D3556.

B. Builder

The cleaning composition includes at least one builder. The builder may comprise at least one salt of a hydroxycarboxylic acid selected from hydroxymonocarboxylic acid or hydroxydicarboxylic acid and at least one oxoacid anion salt. The builder may comprise a hydroxycarboxylic acid salt mixture and at least one oxoacid anion salt. The builder may comprise a hydroxycarboxylic acid salt mixture and an oxoacid anion salt.

The hydroxyl groups of the hydroxycarboxylic acid salt are capable of forming esters when combined with suitable oxoacid anion salts in water. These oxoacid anion esters of hydroxycarboxylic acids can form metal ion sequestering complexes, forming stable, water soluble complexes with metal ions such as calcium and magnesium. The ability of the builder to form these chemical interactions aid in the cleaning and descaling process by removing and preventing undesired metal salts from adhering to the surface of the article being cleaned.

The cleaning composition may comprise, by weight, at least about 1%, at least about 2%, at least about 5%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35%, or at least about 40% of the builder. The cleaning composition may comprise, by weight, about 1% to about 90%, about 1% to about 80%, about 1% to about 75%, about 1% to about 70%, about 1% to about 60%, about 1% to about 50%, about 1% to about 45%, about 1% to about 40%, about 1% to about 35%, about 1% to about 30%, about 1% to about 25%, about 1% to about 20%, about 2% to about 90%, about 2% to about 80%, about 2% to about 75%, about 2% to about 70%, about 2% to about 60%, about 2% to about 50%, about 2% to about 45%, about 2% to about 40%, about 2% to about 35%, about 2% to about 30%, about 2% to about 25%, about 2% to about 20%, about 5% to about 90%, about 5% to about 80%, about 5% to about 75%, about 5% to about 70%, about 5% to about 60%, about 5% to about 50%, about 5% to about 45%, about 5% to about 40%, about 5% to about 35%, about 5% to about 30%, about 5% to about 25%, about 5% to about 20%, about 10% to about 90%, about 10% to about 80%, about 10% to about 75%, about 10% to about 70%, about 10% to about 60%, about 10% to about 50%, about 10% to about 45%, about 10% to about 40%, about 10% to about 35%, about 10% to about 30%, about 10% to about 25%, about 10% to about 20%, about 15% to about 90%, about 15% to about 80%, about 15% to about 75%, about 15% to about 70%, about 15% to about 60%, about 15% to about 50%, about 15% to about 45%, about 15% to about 40%, about 15% to about 35%, about 15% to about 30%, about 15% to about 25%, about 15% to about 20%, about 20% to about 90%, about 20% to about 80%, about 20% to about 75%, about 20% to about 70%, about 20% to about 60%, about 20% to about 50%, about 20% to about 45%, about 20% to about 40%, about 20% to about 35%, about 20% to about 30%, about 20% to about 25%, about 11% to about 25%, about 12% to about 25%, about 13% to about 25%, about 14% to about 25%, about 16% to about 25%, about 17% to about 25%, about 18% to about 25%, about 19% to about 25%, about 10% to about 24%, about 11% to about 24%, about 12% to about 24%, about 13% to about 24%, about 14% to about 24%, about 15% to about 24%, about 16% to about 24%, about 17% to about 24%, about 18% to about 24%, about 19% to about 24%, about 20% to about 24%, about 10% to about 23%, about 11% to about 23%, about 12% to about 23%, about 13% to about 23%, about 14% to about 23%, about 15% to about 23%, about 16% to about 23%, about 17% to about 23%, about 18% to about 23%, about 19% to about 23%, about 20% to about 23%, about 10% to about 22%, about 11% to about 22%, about 12% to about 22%, about 13% to about 22%, about 14% to about 22%, about 15% to about 22%, about 16% to about 22%, about 17% to about 22%, about 18% to about 22%, about 19% to about 22%, about 20% to about 22%, about 10% to about 21%, about 11% to about 21%, about 12% to about 21%, about 13% to about 21%, about 14% to about 21%, about 15% to about 21%, about 16% to about 21%, about 17% to about 21%, about 18% to about 21%, about 19% to about 21%, about 20% to about 21%, about 11% to about 20%, about 12% to about 20%, about 13% to about 20%, about 14% to about 20%, about 16% to about 20%, about 17% to about 20%, about 18% to about 20%, or about 19% to about 20% of the builder. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50% of the builder.

The builder may further comprise sodium nitrate. The sodium nitrate may be present in the builder due to incomplete separation of the nitric acid from the sugar acid oxidation mixture in the preparation of the hydroxycarboxylic acid salt mixture described herein. The builder may comprise, by weight, 0% to about 7%, about 0.1% to about 7%, about 0.5% to about 7%, about 1% to about 7%, about 2% to about 7%, about 3% to about 7%, about 4% to about 7%, about 5% to about 7%, or about 6% to about 7% sodium nitrate. The builder may comprise, by weight, about 0.1%, about 0.5%, about 1%, about 2%, about 3%, about 4%, about 5%, about 6%, or about 7% sodium nitrate.

The builder may further comprise water. The water may be residual from the dry down process of preparing the builder. The builder may comprise, by weight, 0% to about 10%, about 0.1% to about 10%, about 0.5% to about 10%, about 1% to about 10%, about 2% to about 10%, about 3% to about 10%, about 4% to about 10%, about 5% to about 10%, about 6% to about 10%, about 7% to about 10%, about 8% to about 10%, or about 9% to about 10% water. The builder may comprise, by weight, about 0.1%, about 0.5%, about 1%, about 2%, about 3%, about 4%, about 5%, about 6%, about 7%, about 8%, about 9%, or about 10% water.

The specific percentages of the at least one hydroxycarboxylic acid salt and the at least one oxoacid anion salt may vary depending on the desired characteristics of the composition. Generally, compositions with various concentrations of the one or more hydroxycarboxylic acid salts and oxoacid anion salts have varying abilities to bind metal ions according to the pH of the medium from which the metal ion is bound. As such, depending on the pH of the warewashing medium, the relative percentages of hydroxycarboxylic acid salts and oxoacid anion salts may vary as discussed below.

1. Hydroxycarboxylic Acid Salt

The builder comprises at least one salt of a hydroxycarboxylic acid selected from hydroxymonocarboxylic acid or hydroxydicarboxylic acid. Hydroxycarboxylic acids are compounds which contain one or more hydroxyl groups as well as one or more carboxylic acid functionalities. Hydroxymonocarboxylic acids are compounds having only one carboxyl group. Hydroxydicarboxylic acids are compounds having two carboxyl groups. The hydroxyl groups of these compounds are capable of forming metal ion sequestering complexes when combined with a suitable oxoacid anion salt. These complexes form stable, water soluble complexes with metal ions such as calcium and magnesium.

Specific examples of hydroxycarboxylic acid salts that may be used in the cleaning compositions described herein include, but are not limited to, salts of one or more of glucaric acid, xylaric acid, galactaric acid, gluconic acid, 5-keto-gluconic acid, 2-keto-gluconic acid, tartaric acid, tartronic acid, glycolic acid, glyceric acid, oxalic acid, formic acid, glucuronic acid, and combinations thereof. For example, the hydroxycarboxylic acid salt can be one or more of sodium glycolate, potassium glycolate, a glucaric acid salt, a xylaric acid salt, or a galactaric acid salt.

In one embodiment, the at least one salt of a hydroxycarboxylic acid may include a mixture of at least one glucarate salt, at least one gluconate salt, at least one 5-keto-gluconate salt, at least one 2-keto-gluconate salt, at least one tartrate salt, at least one glycolate salt, and at least one tartronate salt.

In one embodiment, the at least one salt of a hydroxycarboxylic acid may include a mixture of at least one glucarate salt, at least one gluconate salt, at least one 5-keto-gluconate salt, at least one 2-keto-gluconate salt, at least one tartrate salt, at least one glycolate salt, at least one tartronate salt, at least one glycerate salt, at least one oxalate salt, and at least one formate salt.

In one embodiment, the at least one salt of a hydroxycarboxylic acid may include a mixture of at least one glucarate salt, at least one gluconate salt, at least one 5-keto-gluconate salt, at least one 2-keto-gluconate salt, at least one tartrate salt, at least one glycolate salt, at least one tartronate salt, at least one glycerate salt, at least one oxalate salt, at least one formate salt, and at least one glucuronic acid salt.

Additionally, one skilled in the art will appreciate that the salts of hydroxycarboxylic acids may encompass salts of all conceivable stereoisomers, including diastereomers and enantiomers, in substantially pure form as well as in any mixing ratio, including the racemates of the hydroxycarboxylic acids.

The builder comprises the salt form of the hydroxycarboxylic acids discussed herein. One of skill in the art will appreciate that salts are generally the compounds that arise from the neutralization reaction of an acid and a base. Any oxidation derivative of a carbohydrate or other polyol may be incorporated in its salt form into the builder. Salts may include, without limitation, potassium, dipotassium, sodium, disodium, lithium, dilithium, zinc, ammonium, diammonium, calcium, magnesium, aluminum, manganese salts and combinations thereof. Non-limiting examples of hydroxycarboxylic acid salts include monopotassium glucarate, disodium glucarate, sodium potassium glucarate, dipotassium glucarate, dilithium glucarate, lithium sodium glucarate, lithium potassium glucarate, zinc glucarate, diammonium glucarate, disodium xylarate, sodium potassium xylarate, dipotassium xylarate, dilithium xylarate, lithium sodium xylarate, lithium potassium xylarate, zinc xylarate, ammonium xylarate sodium gluconate, potassium gluconate, lithium gluconate, zinc gluconate, ammonium gluconate, disodium galactarate, sodium potassium galactarate, dipotassium galactarate, dilithium galactarate, lithium sodium galactarate, lithium potassium galactarate, zinc galactarate, diammonium galactarate, disodium tartrate, sodium potassium tartrate, dipotassium tartrate, dilithium tartrate, lithium sodium tartrate, lithium potassium tartrate, zinc tartrate, diammonium tartrate, disodium tartronate, sodium potassium tartronate, dipotassium tartronate, dilithium tartronate, lithium sodium tartronate, lithium potassium tartronate, zinc tartronate, diammonium tartronate, sodium glycolate, potassium glycolate, lithium glycolate, zinc glycolate, ammonium glycolate, sodium glycerate, potassium glycerate, lithium glycerate, zinc glycerate, ammonium glycerate, disodium glucarate, sodium potassium glucarate, dipotassium glucarate, zinc glucarate, disodium xylarate, sodium potassium xylarate, dipotassium xylarate, zinc xylarate, disodium galactarate, sodium potassium galactarate, dipotassium galactarate, zinc galactarate, diammonium xylarate, sodium 5-keto-gluconate, potassium 5-keto-gluconate, lithium 5-keto-gluconate, zinc 5-keto-gluconate, ammonium 5-keto-gluconate, sodium 2-keto-gluconate, potassium 2-keto-gluconate, lithium 2-keto-gluconate, zinc 2-keto-gluconate, ammonium 2-keto-gluconate, disodium oxalate, sodium formate, sodium glucuronate, and combinations thereof.

In an embodiment, the builder may comprise, by weight, about 20% to about 75% of a glucarate salt, less than about 20% of a gluconate salt, less than about 10% of a 5-keto-gluconate salt, less than about 10% of a 2-keto-gluconate salt, less than about 10% of a tartrate salt, less than about 10% of a tartronate salt, and less than about 10% of a glycolate salt.

In an embodiment, the builder may comprise, by weight, about 40% to about 60% of a glucarate salt, about 5% to about 15% of a gluconate salt, about 3% to about 9% of a 5-keto-gluconate salt, about 5% to about 10% of a tartrate salt, about 5% to about 10% of a tartronate salt, and about 1% to about 5% of a glycolate salt.

In an embodiment, the builder may comprise, by weight, about 45% to about 55% of a glucarate salt, about 10% to about 15% of a gluconate salt, about 4% to about 6% of a 5-keto-gluconate salt, about 5% to about 7% of a tartrate salt, about 5% to about 7% of a tartronate salt, and about 3% to about 5% of a glycolate salt.

In an embodiment, the builder may comprise, by weight, about 50% of a glucarate salt, about 15% of a gluconate salt, about 4% of a 5-keto-gluconate salt, about 6% of a tartrate salt, about 6% of a tartronate salt, and about 5% of a glycolate salt.

In an embodiment, the builder may comprise, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, and 0 to about 10% sodium formate.

In an embodiment, the builder may comprise, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, and 0 to about 2% sodium glucuronate.

The builder may comprise, by weight, about 20% to about 70%, about 20% to about 65%, about 20% to about 60%, about 20% to about 55%, about 20% to about 50%, about 20% to about 45%, about 20% to about 40%, about 20% to about 35%, about 20% to about 30%, about 20% to about 25%, about 25% to about 75%, about 30% to about 75%, about 35% to about 75%, about 40% to about 75%, about 45% to about 75%, about 50% to about 75%, about 55% to about 75%, about 60% to about 75%, about 65% to about 75%, or about 70% to about 75% disodium glucarate. The builder may comprise, by weight, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75% disodium glucarate.

The builder may comprise, by weight, 0% to about 10%, about 0.1% to about 10%, about 0.5% to about 10%, about 1% to about 10%, about 2% to about 10%, about 3% to about 10%, about 4% to about 10%, about 5% to about 10%, about 6% to about 10%, about 7% to about 10%, about 8% to about 10%, or about 9% to about 10% sodium gluconate. The builder may comprise, by weight, about 0.1%, about 0.5%, about 1%, about 2%, about 3%, about 4%, about 5%, about 6%, about 7%, about 8%, about 9%, or about 10% sodium gluconate.

The builder may comprise, by weight, 0% to about 10%, about 0.1% to about 10%, about 0.5% to about 10%, about 1% to about 10%, about 2% to about 10%, about 3% to about 10%, about 4% to about 10%, about 5% to about 10%, about 6% to about 10%, about 7% to about 10%, about 8% to about 10%, or about 9% to about 10% disodium tartrate. The builder may comprise, by weight, about 0.1%, about 0.5%, about 1%, about 2%, about 3%, about 4%, about 5%, about 6%, about 7%, about 8%, about 9%, or about 10% disodium tartrate.

The builder may comprise, by weight, 0% to about 4%, about 0.1% to about 4%, about 0.5% to about 4%, about 1% to about 4%, about 2% to about 4%, about 3% to about 4%, about 0.1% to about 3%, about 0.1% to about 2%, about 0.1% to about 1%, or about 0.1% to about 0.5% disodium tartronate. The builder may comprise, by weight, about 0.1%, about 0.5%, about 1%, about 2%, about 3%, or about 4%, disodium tartronate.

The builder may comprise, by weight, 0% to about 4%, about 0.1% to about 4%, about 0.5% to about 4%, about 1% to about 4%, about 2% to about 4%, about 3% to about 4%, about 0.1% to about 3%, about 0.1% to about 2%, about 0.1% to about 1%, or about 0.1% to about 0.5% sodium glycerate. The builder may comprise, by weight, about 0.1%, about 0.5%, about 1%, about 2%, about 3%, or about 4%, sodium glycerate.

The builder may comprise, by weight, 0% to about 4%, about 0.1% to about 4%, about 0.5% to about 4%, about 1% to about 4%, about 2% to about 4%, about 3% to about 4%, about 0.1% to about 3%, about 0.1% to about 2%, about 0.1% to about 1%, or about 0.1% to about 0.5% sodium glycolate. The builder may comprise, by weight, about 0.1%, about 0.5%, about 1%, about 2%, about 3%, or about 4%, sodium glycolate.

The builder may comprise, by weight, 0% to about 4%, about 0.1% to about 4%, about 0.5% to about 4%, about 1% to about 4%, about 2% to about 4%, about 3% to about 4%, about 0.1% to about 3%, about 0.1% to about 2%, about 0.1% to about 1%, or about 0.1% to about 0.5% sodium 5-ketogluconate. The builder may comprise, by weight, about 0.1%, about 0.5%, about 1%, about 2%, about 3%, or about 4%, sodium 5-ketogluconate.

The builder may comprise, by weight, 0% to about 2%, about 0.1% to about 2%, about 0.5% to about 2%, or about 1% to about 2%, about 0.1% to about 1%, or about 0.1% to about 0.5% sodium 2-ketogluconate. The builder may comprise, by weight, about 0.1%, about 0.5%, about 1%, or about 2% sodium 2-ketogluconate.

The builder may comprise, by weight, 0% to about 10%, about 0.1% to about 10%, about 0.5% to about 10%, about 1% to about 10%, about 2% to about 10%, about 3% to about 10%, about 4% to about 10%, about 5% to about 10%, about 6% to about 10%, about 7% to about 10%, about 8% to about 10%, or about 9% to about 10% disodium oxalate. The builder may comprise, by weight, about 0.1%, about 0.5%, about 1%, about 2%, about 3%, about 4%, about 5%, about 6%, about 7%, about 8%, about 9%, or about 10% disodium oxalate.

The builder may comprise, by weight, 0% to about 10%, about 0.1% to about 10%, about 0.5% to about 10%, about 1% to about 10%, about 2% to about 10%, about 3% to about 10%, about 4% to about 10%, about 5% to about 10%, about 6% to about 10%, about 7% to about 10%, about 8% to about 10%, or about 9% to about 10% sodium formate. The builder may comprise, by weight, about 0.1%, about 0.5%, about 1%, about 2%, about 3%, about 4%, about 5%, about 6%, about 7%, about 8%, about 9%, or about 10% sodium formate.

The builder may comprise, by weight, 0% to about 2%, about 0.1% to about 2%, about 0.5% to about 2%, or about 1% to about 2%, about 0.1% to about 1%, or about 0.1% to about 0.5% sodium glucuronate. The builder may comprise, by weight, about 0.1%, about 0.5%, about 1%, or about 2% sodium glucuronate.

The hydroxycarboxylic acids of the builder may be produced according to any methods currently known in the art, including those described in U.S. Pat. No. 7,692,041, the disclosure of which is herein incorporated by reference in its entirety. Currently employed commercial methods of preparation of the common hydroxycarboxylic acids or salts thereof include biologically induced transformations or fermentations, as for example in the production of tartaric acid (U.S. Pat. No. 2,314,831) and gluconic acid (U.S. Pat. No. 5,017,485). Chemical methods for oxidation also exist, although they are not as prevalent in commercial production. Some chemical oxidation methods suitable for polyol feedstocks include oxidation with oxygen over metal catalysts (U.S. Pat. No. 2,472,168) and oxidation mediated with tetraalkylnitroxyl radical compounds such as TEMPO (U.S. Pat. No. 6,498,269). Additional methods employ nitric acid as the oxidizing agent in aqueous solution and have been described (Kiely, U.S. Pat. No. 7,692,041). The skilled artisan will appreciate that any of the methods described herein, as well as any combination of the methods may be used to obtain the hydroxycarboxylic acid and salts thereof.

The oxidation of polyol feedstocks, such as glucose, will generally produce a mixture of oxidation products. For example, oxidation of glucose by any of the methods listed above will produce hydroxycarboxylic acids including glucaric acid, gluconic acid, 5-keto gluconic acid, 2-keto gluconic acid, glucaric acid, tartaric acid, tartronic acid, and glycolic acids. One of the prevalent hydroxycarboxylic acids produced by these oxidation methods is glucaric acid. It is known within the art that the glucaric acid product in salt form may be selectively isolated from the mixture of other hydroxycarboxylic acids by titration with a base compound such as potassium hydroxide. Salt forms of the mixture of hydroxycarboxylic acids produced by the oxidation of glucose, or selectively isolated glucaric acid may be used in the builder. The use of a mixture of hydroxycarboxylic acid salts provides a cost-efficient process due to a low number of processing steps, and a high product yield.

The builder may comprise, by weight, about 40% to about 95%, about 45% to about 95%, about 50% to about 95%, about 55% to about 95%, about 60% to about 95%, about 65% to about 95%, about 70% to about 95%, about 75% to about 95%, about 80% to about 95%, about 85% to about 95%, about 90% to about 95%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%, about 40% to about 80%, about 45% to about 80%, about 50% to about 80%, about 55% to about 80%, about 60% to about 80%, about 65% to about 80%, about 70% to about 80%, about 75% to about 80%, about 40% to about 75%, about 45% to about 75%, about 50% to about 75%, about 55% to about 75%, about 60% to about 75%, about 65% to about 75%, about 70% to about 75%, about 40% to about 70%, about 45% to about 70%, about 50% to about 70%, about 55% to about 70%, about 60% to about 70%, about 65% to about 70%, about 40% to about 65%, about 45% to about 65%, about 50% to about 65%, about 55% to about 65%, about 60% to about 65%, about 40% to about 60%, about 45% to about 60%, about 50% to about 60%, about 55% to about 60%, about 40% to about 55%, about 45% to about 55%, about 50% to about 55%, about 40% to about 50%, about 45% to about 50%, or about 40% to about 45% of the at least one salt of a hydroxycarboxylic acid.

The cleaning composition may comprise, by weight, at least about 0.5%, at least about 0.6%, at least about 0.7%, at least about 0.8%, at least about 1%, at least about 2%, at least about 3%, at least about 5%, at least about 8%, at least about 10%, at least about 11%, at least about 12%, at least about 13%, at least about 14%, at least about 15%, at least about 16%, at least about 17%, at least about 18%, at least about 19%, or at least about 20% of the at least one salt of hydroxycarboxylic acid. The cleaning composition may comprise, by weight, less than or equal to 50%, less than or equal to 45%, less than or equal to 40%, less than or equal to 35%, less than or equal to 30%, less than or equal to 28%, less than or equal to 25%, less than or equal to 20%, or less than or equal to 15% of the at least one salt of hydroxycarboxylic acid. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the at least one salt of hydroxycarboxylic acid.

2. Oxoacid Anion Salt.

The builder comprises at least one oxoacid anion salt. The performance of hydroxycarboxylic acid salts as sequestering agents for hard water ions can be boosted by the addition of suitable oxoacid anion salts. The boost in performance arises from the formation of diester complexes between the two adjacent hydroxyl groups of the hydroxycarboxylic acid salt and the oxoacid anion salt.

The oxoacid anion salt may be sodium borate, potassium borate, disodium octaborate, sodium metaborate, sodium molybdate, potassium molybdate, aluminum sulfate, aluminum nitrate, aluminum chloride, aluminum formate, sodium aluminate, aluminum hydroxide, aluminum phosphate, sodium stannate, potassium stannate, sodium germanate, potassium germanate, sodium antimonite, potassium antimonite, and combinations thereof.

The builder may comprise, by weight, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 10% to about 70%, about 10% to about 65%, about 10% to about 60%, about 10% to about 55%, about 10% to about 50%, about 10% to about 45%, about 10% to about 40%, about 10% to about 35%, about 10% to about 30%, about 10% to about 25%, about 10% to about 20%, about 10% to about 15%, about 15% to about 70%, about 15% to about 65%, about 15% to about 60%, about 15% to about 55%, about 15% to about 50%, about 15% to about 45%, about 15% to about 40%, about 15% to about 35%, about 15% to about 30%, about 15% to about 25%, about 15% to about 20%, about 20% to about 70%, about 20% to about 65%, about 20% to about 60%, about 20% to about 55%, about 20% to about 50%, about 20% to about 45%, about 20% to about 40%, about 20% to about 35%, about 20% to about 30%, about 20% to about 25%, about 25% to about 70%, about 25% to about 65%, about 25% to about 60%, about 25% to about 55%, about 25% to about 50%, about 25% to about 45%, about 25% to about 40%, about 25% to about 35%, about 25% to about 30%, about 30% to about 70%, about 30% to about 65%, about 30% to about 60%, about 30% to about 55%, about 30% to about 50%, about 30% to about 45%, about 30% to about 40%, about 30% to about 35%, about 35% to about 70%, about 35% to about 65%, about 35% to about 60%, about 35% to about 55%, about 35% to about 50%, about 35% to about 45%, about 35% to about 40%, about 40% to about 70%, about 40% to about 65%, about 40% to about 60%, about 40% to about 55%, about 40% to about 50%, or about 40% to about 45% of the oxoacid anion salt. The builder may comprise, by weight, about 5%, about 10%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 45%, about 50%, about 55%, about 60%, about 65%, or about 70% of the oxoacid anion salt.

The builder may comprise, by weight, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 10% to about 70%, about 10% to about 65%, about 10% to about 60%, about 10% to about 55%, about 10% to about 50%, about 10% to about 45%, about 10% to about 40%, about 10% to about 35%, about 10% to about 30%, about 10% to about 25%, about 10% to about 20%, about 10% to about 15%, about 15% to about 70%, about 15% to about 65%, about 15% to about 60%, about 15% to about 55%, about 15% to about 50%, about 15% to about 45%, about 15% to about 40%, about 15% to about 35%, about 15% to about 30%, about 15% to about 25%, about 15% to about 20%, about 20% to about 70%, about 20% to about 65%, about 20% to about 60%, about 20% to about 55%, about 20% to about 50%, about 20% to about 45%, about 20% to about 40%, about 20% to about 35%, about 20% to about 30%, about 20% to about 25%, about 25% to about 70%, about 25% to about 65%, about 25% to about 60%, about 25% to about 55%, about 25% to about 50%, about 25% to about 45%, about 25% to about 40%, about 25% to about 35%, about 25% to about 30%, about 30% to about 70%, about 30% to about 65%, about 30% to about 60%, about 30% to about 55%, about 30% to about 50%, about 30% to about 45%, about 30% to about 40%, about 30% to about 35%, about 35% to about 70%, about 35% to about 65%, about 35% to about 60%, about 35% to about 55%, about 35% to about 50%, about 35% to about 45%, about 35% to about 40%, about 40% to about 70%, about 40% to about 65%, about 40% to about 60%, about 40% to about 55%, about 40% to about 50%, or about 40% to about 45% sodium aluminate. The builder may comprise, by weight, about 5%, about 10%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 45%, about 50%, about 55%, about 60%, about 65%, or about 70% sodium aluminate.

The cleaning composition may comprise, by weight, at least about 0.05%, at least about 0.1%, at least about 0.25%, at least about 0.5%, at least about 0.75%, at least about 1%, at least about 1.5%, at least about 2%, at least about 3%, at least about 4%, at least about 5%, at least about 6%, at least about 7%, at least about 8%, at least about 9%, or at least about 10% of the oxoacid anion salt. The cleaning composition may comprise, by weight, less than or equal to 30%, less than or equal to 25%, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the oxoacid anion salt. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the oxoacid anion salt.

The cleaning composition may comprise, by weight, at least about 0.05%, at least about 0.1%, at least about 0.25%, at least about 0.5%, at least about 0.75%, at least about 1%, at least about 1.5%, at least about 2%, at least about 3%, at least about 4%, at least about 5%, at least about 6%, at least about 7%, at least about 8%, at least about 9%, or at least about 10% sodium aluminate. The cleaning composition may comprise, by weight, less than or equal to 30%, less than or equal to 25%, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% sodium aluminate. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% sodium aluminate.

In an embodiment, the builder may comprise, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, and about 15% to about 40% sodium aluminate.

C. Dispersant

The cleaning composition includes at least one dispersant combined with the builder. The dispersant may act as a dispersing agent. Dispersants may be a non-surface active polymer or a surface-active substance added to a suspension, usually a colloid, to improve the separation of particles and to prevent settling or clumping. Dispersants may act to disperse oils, soils, food products and wastes, and other physically hard to remove substances from various surfaces.

The dispersant may be polymeric and, combined with the builder of the present disclosure, provide a superior cleaning composition. The dispersant may be carboxymethyl inulin, polyaspartic acid, a homopolymer of acrylic acid with molecular weight of about 4500 g/mol, or mixtures thereof.

The cleaning composition may comprise, by weight, at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.5%, at least about 5%, at least about 5.5%, at least about 6%, at least about 6.5%, at least about 7%, at least about 7.5%, at least about 8%, at least about 8.5%, at least about 9%, or at least about 9.5% the dispersant. The cleaning composition may comprise, by weight, about 0.01% to about 15%, about 0.01% to about 14%, about 0.01% to about 13%, about 0.01% to about 12%, about 0.01% to about 11%, about 0.01% to about 10%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, about 0.01% to about 1%, about 0.1% to about 15%, about 0.1% to about 14%, about 0.1% to about 13%, about 0.1% to about 12%, about 0.1% to about 11%, about 0.1% to about 10%, about 0.1% to about 9%, about 0.1% to about 8%, about 0.1% to about 7%, about 0.1% to about 6%, about 0.1% to about 5%, about 0.1% to about 4%, about 0.1% to about 3%, about 0.1% to about 2%, about 0.1% to about 1%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 14%, about 2% to about 13%, about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 14%, about 3% to about 13%, about 3% to about 12%, about 3% to about 11%, about 3% to about 10%, about 3% to about 9%, about 3% to about 8%, about 3% to about 7%, about 3% to about 6%, about 3% to about 5%, about 3% to about 4%, about 4% to about 15%, about 4% to about 14%, about 4% to about 13%, about 4% to about 12%, about 4% to about 11%, about 4% to about 10%, about 4% to about 9%, about 4% to about 8%, about 4% to about 7%, about 4% to about 6%, about 4% to about 5%, about 0.2% to about 5%, about 0.2% to about 4%, about 0.2% to about 3%, about 0.2% to about 2%, about 0.2% to about 1%, about 0.3% to about 5%, about 0.3% to about 4%, about 0.3% to about 3%, about 0.3% to about 2%, about 0.3% to about 1%, about 0.4% to about 5%, about 0.4% to about 4%, about 0.4% to about 3%, about 0.4% to about 2%, about 0.4% to about 1%, about 0.5% to about 5%, about 0.5% to about 4%, about 0.5% to about 3%, about 0.5% to about 2%, about 0.5% to about 1%, about 0.6% to about 5%, about 0.6% to about 4%, about 0.6% to about 3%, about 0.6% to about 2%, about 0.6% to about 1%, about 0.7% to about 5%, about 0.7% to about 4%, about 0.7% to about 3%, about 0.7% to about 2%, about 0.7% to about 1%, about 0.8% to about 5%, about 0.8% to about 4%, about 0.8% to about 3%, about 0.8% to about 2%, about 0.8% to about 1%, about 0.9% to about 5%, about 0.9% to about 4%, about 0.9% to about 3%, about 0.9% to about 2%, about 0.9% to about 1%, about 1.1% to about 5%, about 1.1% to about 4%, about 1.1% to about 3%, about 1.1% to about 2%, about 1.2% to about 5%, about 1.2% to about 4%, about 1.2% to about 3%, about 1.2% to about 2%, about 1.3% to about 5%, about 1.3% to about 4%, about 1.3% to about 3%, about 1.3% to about 2%, about 1.4% to about 5%, about 1.4% to about 4%, about 1.4% to about 3%, about 1.4% to about 2%, about 1.5% to about 5%, about 1.5% to about 4%, about 1.5% to about 3%, about 1.5% to about 2%, about 1.6% to about 5%, about 1.6% to about 4%, about 1.6% to about 3%, about 1.6% to about 2%, about 1.7% to about 5%, about 1.7% to about 4%, about 1.7% to about 3%, about 1.7% to about 2%, about 1.8% to about 5%, about 1.8% to about 4%, about 1.8% to about 3%, about 1.8% to about 2%, about 1.9% to about 5%, about 1.9% to about 4%, about 1.9% to about 3%, about 1.9% to about 2%, about 2.1% to about 5%, about 2.1% to about 4%, about 2.1% to about 3%, about 2.2% to about 5%, about 2.2% to about 4%, about 2.2% to about 3%, about 2.3% to about 5%, about 2.3% to about 4%, about 2.3% to about 3%, about 2.4% to about 5%, about 2.4% to about 4%, about 2.4% to about 3%, about 2.5% to about 5%, about 2.5% to about 4%, about 2.5% to about 3%, about 2.6% to about 5%, about 2.6% to about 4%, about 2.6% to about 3%, about 2.7% to about 5%, about 2.7% to about 4%, about 2.7% to about 3%, about 2.8% to about 5%, about 2.8% to about 4%, about 2.8% to about 3%, about 2.9% to about 5%, about 2.9% to about 4%, about 2.9% to about 3%, about 3.1% to about 5%, about 3.1% to about 4%, about 3.2% to about 5%, about 3.2% to about 4%, about 3.3% to about 5%, about 3.3% to about 4%, about 3.4% to about 5%, about 3.4% to about 4%, about 3.5% to about 5%, about 3.5% to about 4%, about 3.6% to about 5%, about 3.6% to about 4%, about 3.7% to about 5%, about 3.7% to about 4%, about 3.8% to about 5%, about 3.8% to about 4%, about 3.9% to about 5%, or about 3.9% to about 4% of the dispersant. The cleaning composition may comprise, by weight, about 0.01%, about 0.02%, about 0.03%, about 0.04%, about 0.05%, about 0.06%, about 0.07%, about 0.08%, about 0.09%, about 0.1%, about 1.1%, about 1.2%, about 1.3%, about 1.4%, about 1.5%, about 1.6%, about 1.7%, about 1.8%, about 1.9%, about 2%, about 2.1% about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 4%, about 5%, about 6%, about 7%, about 8%, about 9%, about 10%, about 11%, about 12%, about 13%, about 14%, or about 15% of the dispersant.

1. Polyaspartic Acid

The dispersant may be polyaspartic acid. Polyaspartic acid is an environmentally friendly biodegradable, water-soluble polyaminoacid. It can inhibit deposition of calcium carbonate, calcium sulfate, barium sulfate and calcium phosphate salts and can be used as an antiscalining agent in cooling water systems, water desalination processes, and waste water treatment operations. In addition, and due to its ability to chelate metal ions it provides corrosion inhibition. It can also be used as biodegradable detergent and dispersant for various applications.

The cleaning composition may comprise, by weight, at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.5%, at least about 5%, at least about 5.5%, at least about 6%, at least about 6.5%, at least about 7%, at least about 7.5%, at least about 8%, at least about 8.5%, at least about 9%, or at least about 9.5% the polyaspartic acid. The cleaning composition may comprise, by weight, about 0.01% to about 15%, about 0.01% to about 14%, about 0.01% to about 13%, about 0.01% to about 12%, about 0.01% to about 11%, about 0.01% to about 10%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, about 0.01% to about 1%, about 0.1% to about 15%, about 0.1% to about 14%, about 0.1% to about 13%, about 0.1% to about 12%, about 0.1% to about 11%, about 0.1% to about 10%, about 0.1% to about 9%, about 0.1% to about 8%, about 0.1% to about 7%, about 0.1% to about 6%, about 0.1% to about 5%, about 0.1% to about 4%, about 0.1% to about 3%, about 0.1% to about 2%, about 0.1% to about 1%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 14%, about 2% to about 13%, about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 14%, about 3% to about 13%, about 3% to about 12%, about 3% to about 11%, about 3% to about 10%, about 3% to about 9%, about 3% to about 8%, about 3% to about 7%, about 3% to about 6%, about 3% to about 5%, about 3% to about 4%, about 4% to about 15%, about 4% to about 14%, about 4% to about 13%, about 4% to about 12%, about 4% to about 11%, about 4% to about 10%, about 4% to about 9%, about 4% to about 8%, about 4% to about 7%, about 4% to about 6%, about 4% to about 5%, about 0.2% to about 5%, about 0.2% to about 4%, about 0.2% to about 3%, about 0.2% to about 2%, about 0.2% to about 1%, about 0.3% to about 5%, about 0.3% to about 4%, about 0.3% to about 3%, about 0.3% to about 2%, about 0.3% to about 1%, about 0.4% to about 5%, about 0.4% to about 4%, about 0.4% to about 3%, about 0.4% to about 2%, about 0.4% to about 1%, about 0.5% to about 5%, about 0.5% to about 4%, about 0.5% to about 3%, about 0.5% to about 2%, about 0.5% to about 1%, about 0.6% to about 5%, about 0.6% to about 4%, about 0.6% to about 3%, about 0.6% to about 2%, about 0.6% to about 1%, about 0.7% to about 5%, about 0.7% to about 4%, about 0.7% to about 3%, about 0.7% to about 2%, about 0.7% to about 1%, about 0.8% to about 5%, about 0.8% to about 4%, about 0.8% to about 3%, about 0.8% to about 2%, about 0.8% to about 1%, about 0.9% to about 5%, about 0.9% to about 4%, about 0.9% to about 3%, about 0.9% to about 2%, about 0.9% to about 1%, about 1.1% to about 5%, about 1.1% to about 4%, about 1.1% to about 3%, about 1.1% to about 2%, about 1.2% to about 5%, about 1.2% to about 4%, about 1.2% to about 3%, about 1.2% to about 2%, about 1.3% to about 5%, about 1.3% to about 4%, about 1.3% to about 3%, about 1.3% to about 2%, about 1.4% to about 5%, about 1.4% to about 4%, about 1.4% to about 3%, about 1.4% to about 2%, about 1.5% to about 5%, about 1.5% to about 4%, about 1.5% to about 3%, about 1.5% to about 2%, about 1.6% to about 5%, about 1.6% to about 4%, about 1.6% to about 3%, about 1.6% to about 2%, about 1.7% to about 5%, about 1.7% to about 4%, about 1.7% to about 3%, about 1.7% to about 2%, about 1.8% to about 5%, about 1.8% to about 4%, about 1.8% to about 3%, about 1.8% to about 2%, about 1.9% to about 5%, about 1.9% to about 4%, about 1.9% to about 3%, about 1.9% to about 2%, about 2.1% to about 5%, about 2.1% to about 4%, about 2.1% to about 3%, about 2.2% to about 5%, about 2.2% to about 4%, about 2.2% to about 3%, about 2.3% to about 5%, about 2.3% to about 4%, about 2.3% to about 3%, about 2.4% to about 5%, about 2.4% to about 4%, about 2.4% to about 3%, about 2.5% to about 5%, about 2.5% to about 4%, about 2.5% to about 3%, about 2.6% to about 5%, about 2.6% to about 4%, about 2.6% to about 3%, about 2.7% to about 5%, about 2.7% to about 4%, about 2.7% to about 3%, about 2.8% to about 5%, about 2.8% to about 4%, about 2.8% to about 3%, about 2.9% to about 5%, about 2.9% to about 4%, about 2.9% to about 3%, about 3.1% to about 5%, about 3.1% to about 4%, about 3.2% to about 5%, about 3.2% to about 4%, about 3.3% to about 5%, about 3.3% to about 4%, about 3.4% to about 5%, about 3.4% to about 4%, about 3.5% to about 5%, about 3.5% to about 4%, about 3.6% to about 5%, about 3.6% to about 4%, about 3.7% to about 5%, about 3.7% to about 4%, about 3.8% to about 5%, about 3.8% to about 4%, about 3.9% to about 5%, or about 3.9% to about 4% of the polyaspartic acid. The cleaning composition may comprise, by weight, about 0.01%, about 0.02%, about 0.03%, about 0.04%, about 0.05%, about 0.06%, about 0.07%, about 0.08%, about 0.09%, about 0.1%, about 1.1%, about 1.2%, about 1.3%, about 1.4%, about 1.5%, about 1.6%, about 1.7%, about 1.8%, about 1.9%, about 2%, about 2.1% about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 4%, about 5%, about 6%, about 7%, about 8%, about 9%, about 10%, about 11%, about 12%, about 13%, about 14%, or about 15% of the polyaspartic acid.

2. Carboxymethyl Inulin

The dispersant may be carboxymethyl inulin. Carboxymethyl inulin is a polysaccharide formed by carboxylation of a natural carbohydrate obtained from the chicory plant, and is a threshold scale inhibitor for carbonate and sulfate scaling with excellent calcium tolerance, high water solubility and low viscosity. It is an alternative for traditional fossil and phosphorous based chemicals. Carboxymethyl inulin offers a unique combination of antiscaling, sequestration and dispersing properties, therefore it can be considered a multifunctional molecule. Carboxymethyl inulin performs well as a threshold scale inhibitor for various types of scaling due to its three main functionalities: complexing of hard water ions, crystal growth inhibition and dispersancy.

The cleaning composition may comprise, by weight, at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.5%, at least about 5%, at least about 5.5%, at least about 6%, at least about 6.5%, at least about 7%, at least about 7.5%, at least about 8%, at least about 8.5%, at least about 9%, or at least about 9.5% of the carboxymethyl inulin. The cleaning composition may comprise, by weight, about 0.01% to about 15%, about 0.01% to about 14%, about 0.01% to about 13%, about 0.01% to about 12%, about 0.01% to about 11%, about 0.01% to about 10%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, about 0.01% to about 1%, about 0.1% to about 15%, about 0.1% to about 14%, about 0.1% to about 13%, about 0.1% to about 12%, about 0.1% to about 11%, about 0.1% to about 10%, about 0.1% to about 9%, about 0.1% to about 8%, about 0.1% to about 7%, about 0.1% to about 6%, about 0.1% to about 5%, about 0.1% to about 4%, about 0.1% to about 3%, about 0.1% to about 2%, about 0.1% to about 1%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 14%, about 2% to about 13%, about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 14%, about 3% to about 13%, about 3% to about 12%, about 3% to about 11%, about 3% to about 10%, about 3% to about 9%, about 3% to about 8%, about 3% to about 7%, about 3% to about 6%, about 3% to about 5%, about 3% to about 4%, about 4% to about 15%, about 4% to about 14%, about 4% to about 13%, about 4% to about 12%, about 4% to about 11%, about 4% to about 10%, about 4% to about 9%, about 4% to about 8%, about 4% to about 7%, about 4% to about 6%, about 4% to about 5%, about 0.2% to about 5%, about 0.2% to about 4%, about 0.2% to about 3%, about 0.2% to about 2%, about 0.2% to about 1%, about 0.3% to about 5%, about 0.3% to about 4%, about 0.3% to about 3%, about 0.3% to about 2%, about 0.3% to about 1%, about 0.4% to about 5%, about 0.4% to about 4%, about 0.4% to about 3%, about 0.4% to about 2%, about 0.4% to about 1%, about 0.5% to about 5%, about 0.5% to about 4%, about 0.5% to about 3%, about 0.5% to about 2%, about 0.5% to about 1%, about 0.6% to about 5%, about 0.6% to about 4%, about 0.6% to about 3%, about 0.6% to about 2%, about 0.6% to about 1%, about 0.7% to about 5%, about 0.7% to about 4%, about 0.7% to about 3%, about 0.7% to about 2%, about 0.7% to about 1%, about 0.8% to about 5%, about 0.8% to about 4%, about 0.8% to about 3%, about 0.8% to about 2%, about 0.8% to about 1%, about 0.9% to about 5%, about 0.9% to about 4%, about 0.9% to about 3%, about 0.9% to about 2%, about 0.9% to about 1%, about 1.1% to about 5%, about 1.1% to about 4%, about 1.1% to about 3%, about 1.1% to about 2%, about 1.2% to about 5%, about 1.2% to about 4%, about 1.2% to about 3%, about 1.2% to about 2%, about 1.3% to about 5%, about 1.3% to about 4%, about 1.3% to about 3%, about 1.3% to about 2%, about 1.4% to about 5%, about 1.4% to about 4%, about 1.4% to about 3%, about 1.4% to about 2%, about 1.5% to about 5%, about 1.5% to about 4%, about 1.5% to about 3%, about 1.5% to about 2%, about 1.6% to about 5%, about 1.6% to about 4%, about 1.6% to about 3%, about 1.6% to about 2%, about 1.7% to about 5%, about 1.7% to about 4%, about 1.7% to about 3%, about 1.7% to about 2%, about 1.8% to about 5%, about 1.8% to about 4%, about 1.8% to about 3%, about 1.8% to about 2%, about 1.9% to about 5%, about 1.9% to about 4%, about 1.9% to about 3%, about 1.9% to about 2%, about 2.1% to about 5%, about 2.1% to about 4%, about 2.1% to about 3%, about 2.2% to about 5%, about 2.2% to about 4%, about 2.2% to about 3%, about 2.3% to about 5%, about 2.3% to about 4%, about 2.3% to about 3%, about 2.4% to about 5%, about 2.4% to about 4%, about 2.4% to about 3%, about 2.5% to about 5%, about 2.5% to about 4%, about 2.5% to about 3%, about 2.6% to about 5%, about 2.6% to about 4%, about 2.6% to about 3%, about 2.7% to about 5%, about 2.7% to about 4%, about 2.7% to about 3%, about 2.8% to about 5%, about 2.8% to about 4%, about 2.8% to about 3%, about 2.9% to about 5%, about 2.9% to about 4%, about 2.9% to about 3%, about 3.1% to about 5%, about 3.1% to about 4%, about 3.2% to about 5%, about 3.2% to about 4%, about 3.3% to about 5%, about 3.3% to about 4%, about 3.4% to about 5%, about 3.4% to about 4%, about 3.5% to about 5%, about 3.5% to about 4%, about 3.6% to about 5%, about 3.6% to about 4%, about 3.7% to about 5%, about 3.7% to about 4%, about 3.8% to about 5%, about 3.8% to about 4%, about 3.9% to about 5%, or about 3.9% to about 4% of the carboxymethyl inulin. The cleaning composition may comprise, by weight, about 0.01%, about 0.02%, about 0.03%, about 0.04%, about 0.05%, about 0.06%, about 0.07%, about 0.08%, about 0.09%, about 0.1%, about 1.1%, about 1.2%, about 1.3%, about 1.4%, about 1.5%, about 1.6%, about 1.7%, about 1.8%, about 1.9%, about 2%, about 2.1% about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 4%, about 5%, about 6%, about 7%, about 8%, about 9%, about 10%, about 11%, about 12%, about 13%, about 14%, or about 15% of the carboxymethyl inulin.

3. Homopolymer of Acrylic Acid

The dispersant may be a homopolymer of acrylic acid with molecular weight of about 4500 g/mol. It is effective at dispersing soils and helps to prevent their redeposition on surfaces in particular glass and dishware. The homopolymer of acrylic acid with molecular weight of about 4500 g/mol increases the solubility of precipitating salts by the threshold effect. This allows it to reduce in the wash bath precipitation of inorganic salts (carbonates, phosphates, sulphates of Ca and Mg). It also inhibits crystal growth, preventing precipitation of carbonates, phosphates, or silicates. It disperses precipitates in the cleaning bath to avoid settling and scaling on surfaces and fibers. It also improves filming maintenance by soil dispersion, which minimizes organic components deposition on glass and dishwares. It can also act to increase bleach stability, especially in chlorinated formulations, by binding heavy metals which destabilize chlorine species through catalytic reactions. One embodiment of the homopolymer of acrylic acid with molecular weight of about 4500 g/mol may be Acusol 445.

The cleaning composition may comprise, by weight, at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.5%, at least about 5%, at least about 5.5%, at least about 6%, at least about 6.5%, at least about 7%, at least about 7.5%, at least about 8%, at least about 8.5%, at least about 9%, or at least about 9.5% of the homopolymer of acrylic acid with molecular weight of about 4500 g/mol. The cleaning composition may comprise, by weight, about 0.01% to about 15%, about 0.01% to about 14%, about 0.01% to about 13%, about 0.01% to about 12%, about 0.01% to about 11%, about 0.01% to about 10%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, about 0.01% to about 1%, about 0.1% to about 15%, about 0.1% to about 14%, about 0.1% to about 13%, about 0.1% to about 12%, about 0.1% to about 11%, about 0.1% to about 10%, about 0.1% to about 9%, about 0.1% to about 8%, about 0.1% to about 7%, about 0.1% to about 6%, about 0.1% to about 5%, about 0.1% to about 4%, about 0.1% to about 3%, about 0.1% to about 2%, about 0.1% to about 1%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 14%, about 2% to about 13%, about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 14%, about 3% to about 13%, about 3% to about 12%, about 3% to about 11%, about 3% to about 10%, about 3% to about 9%, about 3% to about 8%, about 3% to about 7%, about 3% to about 6%, about 3% to about 5%, about 3% to about 4%, about 4% to about 15%, about 4% to about 14%, about 4% to about 13%, about 4% to about 12%, about 4% to about 11%, about 4% to about 10%, about 4% to about 9%, about 4% to about 8%, about 4% to about 7%, about 4% to about 6%, about 4% to about 5%, about 0.2% to about 5%, about 0.2% to about 4%, about 0.2% to about 3%, about 0.2% to about 2%, about 0.2% to about 1%, about 0.3% to about 5%, about 0.3% to about 4%, about 0.3% to about 3%, about 0.3% to about 2%, about 0.3% to about 1%, about 0.4% to about 5%, about 0.4% to about 4%, about 0.4% to about 3%, about 0.4% to about 2%, about 0.4% to about 1%, about 0.5% to about 5%, about 0.5% to about 4%, about 0.5% to about 3%, about 0.5% to about 2%, about 0.5% to about 1%, about 0.6% to about 5%, about 0.6% to about 4%, about 0.6% to about 3%, about 0.6% to about 2%, about 0.6% to about 1%, about 0.7% to about 5%, about 0.7% to about 4%, about 0.7% to about 3%, about 0.7% to about 2%, about 0.7% to about 1%, about 0.8% to about 5%, about 0.8% to about 4%, about 0.8% to about 3%, about 0.8% to about 2%, about 0.8% to about 1%, about 0.9% to about 5%, about 0.9% to about 4%, about 0.9% to about 3%, about 0.9% to about 2%, about 0.9% to about 1%, about 1.1% to about 5%, about 1.1% to about 4%, about 1.1% to about 3%, about 1.1% to about 2%, about 1.2% to about 5%, about 1.2% to about 4%, about 1.2% to about 3%, about 1.2% to about 2%, about 1.3% to about 5%, about 1.3% to about 4%, about 1.3% to about 3%, about 1.3% to about 2%, about 1.4% to about 5%, about 1.4% to about 4%, about 1.4% to about 3%, about 1.4% to about 2%, about 1.5% to about 5%, about 1.5% to about 4%, about 1.5% to about 3%, about 1.5% to about 2%, about 1.6% to about 5%, about 1.6% to about 4%, about 1.6% to about 3%, about 1.6% to about 2%, about 1.7% to about 5%, about 1.7% to about 4%, about 1.7% to about 3%, about 1.7% to about 2%, about 1.8% to about 5%, about 1.8% to about 4%, about 1.8% to about 3%, about 1.8% to about 2%, about 1.9% to about 5%, about 1.9% to about 4%, about 1.9% to about 3%, about 1.9% to about 2%, about 2.1% to about 5%, about 2.1% to about 4%, about 2.1% to about 3%, about 2.2% to about 5%, about 2.2% to about 4%, about 2.2% to about 3%, about 2.3% to about 5%, about 2.3% to about 4%, about 2.3% to about 3%, about 2.4% to about 5%, about 2.4% to about 4%, about 2.4% to about 3%, about 2.5% to about 5%, about 2.5% to about 4%, about 2.5% to about 3%, about 2.6% to about 5%, about 2.6% to about 4%, about 2.6% to about 3%, about 2.7% to about 5%, about 2.7% to about 4%, about 2.7% to about 3%, about 2.8% to about 5%, about 2.8% to about 4%, about 2.8% to about 3%, about 2.9% to about 5%, about 2.9% to about 4%, about 2.9% to about 3%, about 3.1% to about 5%, about 3.1% to about 4%, about 3.2% to about 5%, about 3.2% to about 4%, about 3.3% to about 5%, about 3.3% to about 4%, about 3.4% to about 5%, about 3.4% to about 4%, about 3.5% to about 5%, about 3.5% to about 4%, about 3.6% to about 5%, about 3.6% to about 4%, about 3.7% to about 5%, about 3.7% to about 4%, about 3.8% to about 5%, about 3.8% to about 4%, about 3.9% to about 5%, or about 3.9% to about 4% of the homopolymer of acrylic acid with molecular weight of about 4500 g/mol. The cleaning composition may comprise, by weight, about 0.01%, about 0.02%, about 0.03%, about 0.04%, about 0.05%, about 0.06%, about 0.07%, about 0.08%, about 0.09%, about 0.1%, about 1.1%, about 1.2%, about 1.3%, about 1.4%, about 1.5%, about 1.6%, about 1.7%, about 1.8%, about 1.9%, about 2%, about 2.1% about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 4%, about 5%, about 6%, about 7%, about 8%, about 9%, about 10%, about 11%, about 12%, about 13%, about 14%, or about 15% of the homopolymer of acrylic acid with molecular weight of about 4500 g/mol.

The cleaning composition may comprise, by weight, at least about 0.01%, at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.1%, at least about 1.2%, at least about 1.3%, at least about 1.4%, at least about 1.5%, at least about 1.6%, at least about 1.7%, at least about 1.8%, at least about 1.9%, at least about 2%, at least about 2.1%, at least about 2.2%, at least about 2.3%, at least about 2.4%, at least about 2.5%, at least about 2.6%, at least about 2.7%, at least about 2.8%, at least about 2.9%, at least about 3%, at least about 3.1%, at least about 3.2%, at least about 3.3%, at least about 3.4%, at least about 3.5%, at least about 3.6%, at least about 3.7%, at least about 3.8%, at least about 3.9%, at least about 4%, at least about 4.5%, at least about 5%, at least about 5.5%, at least about 6%, at least about 6.5%, at least about 7%, at least about 7.5%, at least about 8%, at least about 8.5%, at least about 9%, or at least about 9.5% of the Acusol 445. The cleaning composition may comprise, by weight, about 0.01% to about 15%, about 0.01% to about 14%, about 0.01% to about 13%, about 0.01% to about 12%, about 0.01% to about 11%, about 0.01% to about 10%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, about 0.01% to about 1%, about 0.1% to about 15%, about 0.1% to about 14%, about 0.1% to about 13%, about 0.1% to about 12%, about 0.1% to about 11%, about 0.1% to about 10%, about 0.1% to about 9%, about 0.1% to about 8%, about 0.1% to about 7%, about 0.1% to about 6%, about 0.1% to about 5%, about 0.1% to about 4%, about 0.1% to about 3%, about 0.1% to about 2%, about 0.1% to about 1%, about 1% to about 15%, about 1% to about 14%, about 1% to about 13%, about 1% to about 12%, about 1% to about 11%, about 1% to about 10%, about 1% to about 9%, about 1% to about 8%, about 1% to about 7%, about 1% to about 6%, about 1% to about 5%, about 1% to about 4%, about 1% to about 3%, about 1% to about 2%, about 2% to about 15%, about 2% to about 14%, about 2% to about 13%, about 2% to about 12%, about 2% to about 11%, about 2% to about 10%, about 2% to about 9%, about 2% to about 8%, about 2% to about 7%, about 2% to about 6%, about 2% to about 5%, about 2% to about 4%, about 2% to about 3%, about 3% to about 15%, about 3% to about 14%, about 3% to about 13%, about 3% to about 12%, about 3% to about 11%, about 3% to about 10%, about 3% to about 9%, about 3% to about 8%, about 3% to about 7%, about 3% to about 6%, about 3% to about 5%, about 3% to about 4%, about 4% to about 15%, about 4% to about 14%, about 4% to about 13%, about 4% to about 12%, about 4% to about 11%, about 4% to about 10%, about 4% to about 9%, about 4% to about 8%, about 4% to about 7%, about 4% to about 6%, about 4% to about 5%, about 0.2% to about 5%, about 0.2% to about 4%, about 0.2% to about 3%, about 0.2% to about 2%, about 0.2% to about 1%, about 0.3% to about 5%, about 0.3% to about 4%, about 0.3% to about 3%, about 0.3% to about 2%, about 0.3% to about 1%, about 0.4% to about 5%, about 0.4% to about 4%, about 0.4% to about 3%, about 0.4% to about 2%, about 0.4% to about 1%, about 0.5% to about 5%, about 0.5% to about 4%, about 0.5% to about 3%, about 0.5% to about 2%, about 0.5% to about 1%, about 0.6% to about 5%, about 0.6% to about 4%, about 0.6% to about 3%, about 0.6% to about 2%, about 0.6% to about 1%, about 0.7% to about 5%, about 0.7% to about 4%, about 0.7% to about 3%, about 0.7% to about 2%, about 0.7% to about 1%, about 0.8% to about 5%, about 0.8% to about 4%, about 0.8% to about 3%, about 0.8% to about 2%, about 0.8% to about 1%, about 0.9% to about 5%, about 0.9% to about 4%, about 0.9% to about 3%, about 0.9% to about 2%, about 0.9% to about 1%, about 1.1% to about 5%, about 1.1% to about 4%, about 1.1% to about 3%, about 1.1% to about 2%, about 1.2% to about 5%, about 1.2% to about 4%, about 1.2% to about 3%, about 1.2% to about 2%, about 1.3% to about 5%, about 1.3% to about 4%, about 1.3% to about 3%, about 1.3% to about 2%, about 1.4% to about 5%, about 1.4% to about 4%, about 1.4% to about 3%, about 1.4% to about 2%, about 1.5% to about 5%, about 1.5% to about 4%, about 1.5% to about 3%, about 1.5% to about 2%, about 1.6% to about 5%, about 1.6% to about 4%, about 1.6% to about 3%, about 1.6% to about 2%, about 1.7% to about 5%, about 1.7% to about 4%, about 1.7% to about 3%, about 1.7% to about 2%, about 1.8% to about 5%, about 1.8% to about 4%, about 1.8% to about 3%, about 1.8% to about 2%, about 1.9% to about 5%, about 1.9% to about 4%, about 1.9% to about 3%, about 1.9% to about 2%, about 2.1% to about 5%, about 2.1% to about 4%, about 2.1% to about 3%, about 2.2% to about 5%, about 2.2% to about 4%, about 2.2% to about 3%, about 2.3% to about 5%, about 2.3% to about 4%, about 2.3% to about 3%, about 2.4% to about 5%, about 2.4% to about 4%, about 2.4% to about 3%, about 2.5% to about 5%, about 2.5% to about 4%, about 2.5% to about 3%, about 2.6% to about 5%, about 2.6% to about 4%, about 2.6% to about 3%, about 2.7% to about 5%, about 2.7% to about 4%, about 2.7% to about 3%, about 2.8% to about 5%, about 2.8% to about 4%, about 2.8% to about 3%, about 2.9% to about 5%, about 2.9% to about 4%, about 2.9% to about 3%, about 3.1% to about 5%, about 3.1% to about 4%, about 3.2% to about 5%, about 3.2% to about 4%, about 3.3% to about 5%, about 3.3% to about 4%, about 3.4% to about 5%, about 3.4% to about 4%, about 3.5% to about 5%, about 3.5% to about 4%, about 3.6% to about 5%, about 3.6% to about 4%, about 3.7% to about 5%, about 3.7% to about 4%, about 3.8% to about 5%, about 3.8% to about 4%, about 3.9% to about 5%, or about 3.9% to about 4% of the Acusol 445. The cleaning composition may comprise, by weight, about 0.01%, about 0.02%, about 0.03%, about 0.04%, about 0.05%, about 0.06%, about 0.07%, about 0.08%, about 0.09%, about 0.1%, about 1.1%, about 1.2%, about 1.3%, about 1.4%, about 1.5%, about 1.6%, about 1.7%, about 1.8%, about 1.9%, about 2%, about 2.1% about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 4%, about 5%, about 6%, about 7%, about 8%, about 9%, about 10%, about 11%, about 12%, about 13%, about 14%, or about 15% of the Acusol 445.

D. Combination of Builder and Dispersant

Accordingly, the combination of specific builders and dispersants in the cleaning composition leads to a composition that is an unexpectedly superior cleaning composition. For example, the combination of a builder comprising at least one salt of a hydroxycarboxylic acid selected from hydroxymonocarboxylic acid or hydroxydicarboxylic acid and at least one oxoacid anion salt and a polymeric dispersant, such as polyaspartic acid, carboxymethyl inulin or the homopolymer of acrylic acid with molecular weight of about 4500 g/mol results in a cleaning composition with synergistic improvements in cleaning capabilities. In particular, these combinations result in compositions that display up to a 59% synergistic improvement in spotting performance and up to a 48% synergistic improvement in filming performance. The combinations of these specific dispersants (polyaspartic acid, carboxymethyl inulin, a homopolymer of acrylic acid with molecular weight of about 4500 g/mol) with other builders do not demonstrate any synergistic improvement in cleaning capability. The combinations of this specific builder (at least one salt of a hydroxycarboxylic acid selected from hydroxymonocarboxylic acid or hydroxydicarboxylic acid and at least one oxoacid anion salt) with other dispersants do not demonstrate any synergistic improvement in cleaning capability.

E. Other Components

The cleaning composition may comprise other components, such as additives. The additional additives may be included in the cleaning compositions, provided the additives do not adversely impact the overall ability of the cleaning compositions to effectively clean. Typical additives may include, but are not limited to organic detergents, cleaning agents, rinse aids, bleaching agents, sanitizers/anti-microbial agents, activators including bleach activators, detergent fillers, defoaming agents, anti-redeposition agents, optical brighteners, anti-static agents, anti-wrinkling agents, odor capturing agents, fiber protection agents, color protection agents, UV protection agents, anti-pilling agents, water repellency agents, insect repellants, dyes/odorants, additional hardening/solubility modifiers, co-builders including organic co-builders and inorganic co-builders, dispersing agents, surfactants, or any other natural or synthetic agent capable of altering the properties of the cleaning composition.

1. Low Foaming Non-Ionic Surfactant

The cleaning composition can include at least one surfactant or surfactant system as an additive. The surfactant may be a low-foaming non-ionic surfactant. A variety of surfactants can be used in a cleaning composition, such as anionic, non-ionic, cationic, and zwitterionic surfactants. Any suitable co-surfactant in any suitable amount or form may be used in the cleaning composition. Suitable co-surfactants include anionic surfactants, cationic surfactants, nonionic surfactants, amphoteric surfactants, ampholytic surfactants, zwitterionic surfactants, and mixtures thereof. For example, a co-surfactant may be used in a surfactant system or mixed surfactant system comprising two or more distinct surfactants (such as, a charged co-surfactant selected from nonionic surfactants, zwitterionic surfactants, anionic surfactants, and mixtures thereof).

Nonionic surfactants useful in the cleaning composition include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC® (BASF-Wyandotte) and PLURAFAC® (BASF), and the like; and other like nonionic compounds, or mixtures thereof. Silicone surfactants such as the ABIL® B8852 can also be used.

The surfactant can be selected to provide low foaming properties. Low-foaming nonionic surfactants useful in the cleaning compositions include poloxamers, fatty acid ethoxylates, secondary alcohol ethoxylates or mixtures thereof. One would understand that low foaming surfactants that provide the desired level of detersive activity are advantageous in an environment such as a dishwashing machine where the presence of large amounts of foaming can be problematic. In addition to selecting low foaming surfactants, one would understand that defoaming agents can be utilized to reduce the generation of foam. Accordingly, surfactants that are considered low foaming surfactants as well as other surfactants can be used in the cleaning composition and the level of foaming can be controlled by the addition of a defoaming agent.

The cleaning composition described herein may comprise a low-foaming, nonionic surfactant in any suitable amount or form. When compared to typical cleaning compositions without low-foaming, nonionic surfactants, the cleaning compositions described herein exhibit excellent sudsing control. Low-foaming, nonionic surfactants are most typically used to confer improved water-sheeting action (especially on glassware). Low-foaming, nonionic surfactant surfactants generally are well known, being described in more detail in Kirk Othmer's Encyclopedia of Chemical Technology, 3rd Ed., Vol. 22, pp. 360-379, “Surfactants and Detersive Systems”.

At least one of the low-foaming, nonionic surfactant can have a low cloud point. “Cloud point”, as used herein, is a well-known property of nonionic surfactants which is the result of the surfactant becoming less soluble with increasing temperature, the temperature at which the appearance of a second phase is observable is referred to as the “cloud point” (See Kirk Othmer's Encyclopedia of Chemical Technology, 3rd Ed., Vol. 22, pp. 360-362, “Surfactants and Detersive Systems”.)

A “low cloud point” low-foaming, nonionic surfactant may be defined as a nonionic surfactant having a cloud point of less than about 32° C. “Low cloud point” low-foaming, nonionic surfactants may, for instance, have a cloud point of less than about 30° C., less than about 28° C., less than about 26° C., less than about 24° C., less than about 22° C., less than about 20° C., less than about 18° C., less than about 16° C., less than about 14° C., less than about 12° C., less than about 10° C., less than about 8° C., less than about 6° C., less than about 4° C., less than about 2° C. or less than about 0° C.

Typical low cloud point low-foaming, nonionic surfactants include nonionic alkoxylated surfactants; especially ethoxylates derived from primary alcohol, and polyoxypropylene/polyoxyethylene/polyoxypropylene (PO/EO/PO) reverse block polymers. Such low cloud point nonionic surfactants also include, for example, ethoxylated-propoxylated alcohol (e.g., Olin Corporation's POLY-TERGENT® SLF-18) and epoxy-capped poly(oxyalkylated) alcohols (e.g., Olin Corporation's POLY-TERGENT® SLF-18B series of nonionics, as described, for example, in WO 94/22800). Other suitable nonionic surfactants can be prepared by using the processes described in U.S. Pat. No. 4,223,163, incorporated herein by reference in its entirety.

Low cloud point low-foaming, nonionic surfactants may additionally comprise a polyoxyethylene, polyoxypropylene block polymeric compound. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC®, REVERSED PLURONIC®, and TETRONIC® by the BASF-Wyandotte Corp., Wyandotte, Mich., are also suitable in cleaning compositions described herein. Non-limiting examples include REVERSED PLURONIC® 25R2 and TETRONIC® 702. Such surfactants are typically useful herein as low cloud point nonionic surfactants.

The low cloud point low-foaming, nonionic surfactant, described herein, may further have a hydrophile-lipophile balance (“HLB”; see Kirk Othmer hereinbefore) value within the range of from about 1 to about 10; and alternatively, from about 3 to about 8.

A “high cloud point” nonionic surfactant may be defined as a nonionic surfactant or surfactant system ingredient having a cloud point of greater than 40° C. “High cloud point” nonionic surfactants may, for instance, have a cloud point greater than about 50° C., and alternatively greater than about 60° C. Optionally, the cleaning compositions described herein may comprise a high cloud point low-foaming non-ionic surfactant. Any suitable high cloud point nonionic surfactant may be used herein in any suitable amount or form.

The high cloud point low-foaming non-ionic surfactant system may comprise an ethoxylated surfactant derived from the reaction of a monohydroxy alcohol or alkylphenol containing from about 8 to about 20 carbon atoms, with from about 6 to about 15 moles of ethylene oxide per mole of alcohol or alkyl phenol on an average basis. These high cloud point low-foaming non-ionic surfactants may have a hydrophile-lipophile balance (“HLB”; see Kirk Othmer hereinbefore) value within the range of from about 9 to about 15, alternatively from about 11 to about 15. Such high cloud point nonionic surfactants may include, for example, TERGITOL® 15S9 (supplied by Union Carbide), RHODASURF®TMD 8.5 (supplied by Rhone Poulenc), and NEODOL® 91-8 (supplied by Shell).

Suitable high cloud point low-foaming non-ionic surfactants may also be derived from a straight or branched chain or secondary fatty alcohol containing from about 6 to about 20 carbon atoms (C₆-C₂₀ alcohol), including secondary alcohols and branched chain primary alcohols. Preferably, high cloud point nonionic surfactants are branched or secondary alcohol ethoxylates, more preferably mixed C_{9/11} or C_{11/15} branched alcohol ethoxylates, condensed with an average of from about 6 to about 15 moles, from about 6 to about 12 moles, and alternatively, from about 6 to about 9 moles of ethylene oxide per mole of alcohol. The ethoxylated nonionic surfactant so derived may have a narrow ethoxylate distribution relative to the average.

The low-foaming non-ionic surfactant may also encompass suitable polymeric materials in any suitable amount or form. Suitable polymeric materials may include, but are not limited to: silicone polymers, non-silicone polymers, phosphate polymers, or non-phosphate polymers. These polymeric materials are known to defoam food soils commonly encountered in automatic dishwashing processes. Low-foaming non-ionic surfactants can also optionally contain propylene oxide in an amount up to about 15% by weight.

The cleaning composition may comprise, by weight, at least about 0.1%, at least about 0.25%, at least about 0.5%, at least about 0.75%, at least about 1%, at least about 1.25%, at least about 1.5%, at least about 1.75%, at least about 2%, at least about 2.5%, at least about 3%, at least about 3.5%, at least about 4%, at least about 4.5%, at least about 5%, at least about 6%, at least about 7%, at least about 8%, or at least about 9% of the low-foaming non-ionic surfactant. The cleaning composition may comprise, by weight, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the low-foaming non-ionic surfactant. The cleaning composition may comprise, by weight, about 0.1% to about 10%, about 0.2% to about 10%, about 0.3% to about 10%, about 0.4% to about 10%, about 0.5% to about 10%, about 0.6% to about 10%, about 0.7% to about 10%, about 0.8% to about 10%, about 0.9% to about 10%, about 1% to about 10%, about 2% to about 10%, about 3% to about 10%, about 4% to about 10%, about 5% to about 10%, about 0.1% to about 5%, about 0.2% to about 5%, about 0.3% to about 5%, about 0.4% to about 5%, about 0.5% to about 5%, about 0.6% to about 5%, about 0.7% to about 5%, about 0.8% to about 5%, about 0.9% to about 5%, about 1% to about 5%, about 2% to about 5%, about 3% to about 5%, or about 4% to about 5% of the low-foaming non-ionic surfactant. The cleaning composition may comprise, by weight, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, about 6%, about 7%, about 8%, about 9%, or about 10% of the low-foaming non-ionic surfactant.

In an embodiment, the low foaming non-ionic surfactant is an ethylene oxide/propylene oxide block copolymer. The cleaning composition may comprise, by weight, at least about 0.1%, at least about 0.25%, at least about 0.5%, at least about 0.75%, at least about 1%, at least about 1.25%, at least about 1.5%, at least about 1.75%, at least about 2%, at least about 2.5%, at least about 3%, at least about 3.5%, at least about 4%, at least about 4.5%, at least about 5%, at least about 6%, at least about 7%, at least about 8%, or at least about 9% of the ethylene oxide/propylene oxide block copolymer. The cleaning composition may comprise, by weight, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the ethylene oxide/propylene oxide block copolymer. The cleaning composition may comprise, by weight, about 0.1% to about 10%, about 0.2% to about 10%, about 0.3% to about 10%, about 0.4% to about 10%, about 0.5% to about 10%, about 0.6% to about 10%, about 0.7% to about 10%, about 0.8% to about 10%, about 0.9% to about 10%, about 1% to about 10%, about 2% to about 10%, about 3% to about 10%, about 4% to about 10%, about 5% to about 10%, about 0.1% to about 5%, about 0.2% to about 5%, about 0.3% to about 5%, about 0.4% to about 5%, about 0.5% to about 5%, about 0.6% to about 5%, about 0.7% to about 5%, about 0.8% to about 5%, about 0.9% to about 5%, about 1% to about 5%, about 2% to about 5%, about 3% to about 5%, or about 4% to about 5% of the ethylene oxide/propylene oxide block copolymer. The cleaning composition may comprise, by weight, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, about 6%, about 7%, about 8%, about 9%, or about 10% of the ethylene oxide/propylene oxide block copolymer.

2. pH Buffering Agents

The cleaning compositions may contain one or more pH buffering agents as an additive including, without limitation, alkali metal hydroxides, alkali metal carbonates and alkali metal bicarbonates. Examples include, without limitation, sodium hydroxide, potassium hydroxide, sodium carbonate, sodium bicarbonate, potassium carbonate, amino acids, tris(hydroxymethyl)amino methane (TRIS), 2-amino-2-ethyl-1,3-propanediol, 2-amino-2-methyl-propanol, 2-amino-2-methyl-1,3-propanol, potassium glutamate, N-methyl diethanolamide, 1,3-diamino-propanol N,N′-tetra-methyl-1,3-diamino-2-propanol, N,N-bis(2-hydroxyethyl)glycine (bicine), N-tris (hydroxymethyl)methyl glycine (tricine), potassium polyphosphate, and organic diamines.

The cleaning composition may comprise, by weight, at least about 1%, at least about 2%, at least about 3%, at least about 4%, at least about 5%, at least about 10%, at least about 15%, at least about 20%, at least about 25%, at least about 30%, at least about 35%, at least about 36%, at least about 37%, at least about 38%, at least about 39%, at least about 40%, at least about 41%, at least about 42%, at least about 43%, at least about 44%, or at least about 45% of the pH buffering agent. The cleaning composition may comprise, by weight, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, or less than or equal to 5% of the pH buffering agent. The cleaning composition may comprise, by weight, about 1% to about 50%, about 5% to about 50%, about 10% to about 50%, about 15% to about 50%, about 20% to about 50%, about 25% to about 50%, about 30% to about 10%, about 35% to about 50%, about 40% to about 50%, about 45% to about 50%, about 1% to about 45%, about 5% to about 45%, about 10% to about 45%, about 15% to about 45%, about 20% to about 45%, about 25% to about 45%, about 30% to about 45%, about 35% to about 45%, about 40% to about 45%, about 1% to about 40%, about 5% to about 40%, about 10% to about 40%, about 15% to about 40%, about 20% to about 40%, about 25% to about 40%, about 30% to about 40%, about 35% to about 40% of the pH buffering agent. The cleaning composition may comprise, by weight, about 1%, about 5%, about 10%, about 15%, about 20%, about 25%, about 30%, about 31%, about 32%, about 33%, about 34%, about 35%, about 36%, about 37%, about 38%, about 39%, about 40%, about 41%, about 42%, about 43%, about 44%, about 45%, or about 50% of the pH buffering agent.

In an embodiment, the pH buffering agent is sodium carbonate. The cleaning composition may comprise, by weight, at least about 1%, at least about 2%, at least about 3%, at least about 4%, at least about 5%, at least about 10%, at least about 15%, at least about 20%, at least about 25%, at least about 30%, at least about 35%, at least about 36%, at least about 37%, at least about 38%, at least about 39%, at least about 40%, at least about 41%, at least about 42%, at least about 43%, at least about 44%, or at least about 45% of the sodium carbonate. The cleaning composition may comprise, by weight, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, or less than or equal to 5% of the sodium carbonate. The cleaning composition may comprise, by weight, about 1% to about 50%, about 5% to about 50%, about 10% to about 50%, about 15% to about 50%, about 20% to about 50%, about 25% to about 50%, about 30% to about 10%, about 35% to about 50%, about 40% to about 50%, about 45% to about 50%, about 1% to about 45%, about 5% to about 45%, about 10% to about 45%, about 15% to about 45%, about 20% to about 45%, about 25% to about 45%, about 30% to about 45%, about 35% to about 45%, about 40% to about 45%, about 1% to about 40%, about 5% to about 40%, about 10% to about 40%, about 15% to about 40%, about 20% to about 40%, about 25% to about 40%, about 30% to about 40%, about 35% to about 40% of the sodium carbonate. The cleaning composition may comprise, by weight, about 1%, about 5%, about 10%, about 15%, about 20%, about 25%, about 30%, about 31%, about 32%, about 33%, about 34%, about 35%, about 36%, about 37%, about 38%, about 39%, about 40%, about 41%, about 42%, about 43%, about 44%, about 45%, or about 50% of the sodium carbonate.

3. Bleaching Agents

The cleaning compositions may contain one or more bleaching agents as an additive for lightening, stain removal, or sanitizing a substrate, and can include bleaching compounds capable of liberating an active halogen species, such as Cl₂, Br₂, —OCl— and/or —OBr—, or the like, under conditions typically encountered during the cleansing process. The bleach can be organic or inorganic. Examples of suitable bleaching agents include, but are not limited to, chlorine-containing compounds such as chlorine, a hypochlorite or chloramines, a halogenated bleach, an oxidizing bleach, a reducing bleach or any combination thereof. Examples of suitable reducing bleaches include sodium dithionite and sodium hydrosulfite. Examples of suitable halogen-releasing compounds include, but are not limited to: alkali metal dichloroisocyanurates, alkali metal hypochlorites, including, for example, sodium hypochlorite, calcium hypochlorite, potassium hypochlorite, magnesium hypochlorite and chlorinated trisodium phosphate dodecahydrate, monochloramine, and dichloroamine. Encapsulated chlorine sources may also be used to enhance the stability of the chlorine source in the composition. Examples of organic bleaches include potassium dichloroisocyanurate, sodium dichloroisocyanurate, 1,3-dichloro-5,5-dimethlhydantoin, N-chlorosulfamide, chloramine T, dichloramine T, chloramine B, dichloramine T, N,N′-dichlorobenzoylene urea, paratoluene sulfondichoroamide, trichloromethylamine, N-chlorosuccinimide, N-chloroacetyl urea, N,N′-dichloroazodicarbonamide, N,N′-dichlorobiuret and chlorinated dicyandamide.

Examples of other bleaching agents that can be used include sodium dithionite, sodium hydrosulfite or a combination thereof.

The bleaching agent can also include an agent containing or acting as a source of active oxygen. The active oxygen compound acts to provide a source of active oxygen and may release active oxygen in aqueous solutions. An active oxygen compound can be inorganic, organic or a mixture thereof. Examples of suitable active oxygen compounds include, but are not limited to: peroxygen compounds, peroxygen compound adducts, hydrogen peroxide, sodium peroxide, potassium peroxide, urea peroxyhydrate, perborates, organic peroxy compounds, sodium peroxyhydrate, sodium carbonate peroxyhydrate, sodium pyrophosphate peroxyhydrate, potassium peroxyhydrate, phosphate peroxyhydrates, potassium pyrophosphate peroxyhydrate, potassium permonosulfate, sodium percarbonate, potassium percarbonate, and sodium perborate or potassium perborate, mono and tetrahydrate, with and without activators such as tetraacetylethylene diamine (TAED) and cobalt catalysts, and any combination thereof. Cobalt catalysts are described in U.S. Pat. No. 5,962,386, the disclosure of which is herein incorporated by reference in its entirety.

The cleaning composition may comprise, by weight, at least about 0.1%, at least about 0.5%, at least about 0.75%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, or at least about 20% of the bleaching agent. The cleaning composition may comprise, by weight, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 5%, or less than or equal to 1% of the bleaching agent. The cleaning composition may comprise, by weight, about 1% to about 20%, about 1% to about 19%, about 1% to about 18%, about 1% to about 17%, about 1% to about 16%, about 1% to about 15%, about 1% to about 14%, about 1% to about 13%, about 1% to about 12%, about 1% to about 11%, about 1% to about 10%, about 2% to about 20%, about 2% to about 19%, about 2% to about 18%, about 2% to about 17%, about 2% to about 16%, about 2% to about 15%, about 2% to about 14%, about 2% to about 13%, about 2% to about 12%, about 2% to about 11%, about 2% to about 10%, about 3% to about 20%, about 3% to about 19%, about 3% to about 18%, about 3% to about 17%, about 3% to about 16%, about 3% to about 15%, about 3% to about 14%, about 3% to about 13%, about 3% to about 12%, about 3% to about 11%, about 3% to about 10%, about 4% to about 20%, about 4% to about 19%, about 4% to about 18%, about 4% to about 17%, about 4% to about 16%, about 4% to about 15%, about 4% to about 14%, about 4% to about 13%, about 4% to about 12%, about 4% to about 11%, about 4% to about 10%, about 5% to about 20%, about 5% to about 19%, about 5% to about 18%, about 5% to about 17%, about 5% to about 16%, about 5% to about 15%, about 5% to about 14%, about 5% to about 13%, about 5% to about 12%, about 5% to about 11%, about 5% to about 10%, about 6% to about 20%, about 6% to about 19%, about 6% to about 18%, about 6% to about 17%, about 6% to about 16%, about 6% to about 15%, about 6% to about 14%, about 6% to about 13%, about 6% to about 12%, about 6% to about 11%, about 6% to about 10%, about 7% to about 20%, about 7% to about 19%, about 7% to about 18%, about 7% to about 17%, about 7% to about 16%, about 7% to about 15%, about 7% to about 14%, about 7% to about 13%, about 8% to about 20%, about 8% to about 19%, about 8% to about 18%, about 8% to about 17%, about 8% to about 16%, about 8% to about 15%, about 8% to about 14%, about 8% to about 13%, about 9% to about 20%, about 9% to about 19%, about 9% to about 18%, about 9% to about 17%, about 9% to about 16%, about 9% to about 15%, about 9% to about 14% or about 9% to about 13%, about 10% to about 20%, about 10% to about 19%, about 10% to about 18%, about 10% to about 17%, about 10% to about 16%, about 10% to about 15%, about 10% to about 14% or about 10% to about 13%, about 11% to about 19%, about 12% to about 18%, about 13% to about 18%, about 14% to about 18%, about 14% to about 19%, about 14% to about 17%, about 14% to about 16%, about 13% to about 16%, about 13% to about 17%, or about 14% to about 15% of the bleaching agent. The cleaning composition may comprise, by weight, about 1%, about 5%, about 10%, about 11%, about 12%, about 13%, about 14%, about 15%, about 16%, about 17%, about 18%, about 19%, or about 20% of the bleaching agent.

In an embodiment, the bleaching agent is sodium percarbonate. The cleaning composition may comprise, by weight, at least about 0.1%, at least about 0.5%, at least about 0.75%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, or at least about 20% of the sodium percarbonate. The cleaning composition may comprise, by weight, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 5%, or less than or equal to 1% of the sodium percarbonate. The cleaning composition may comprise, by weight, about 1% to about 20%, about 1% to about 19%, about 1% to about 18%, about 1% to about 17%, about 1% to about 16%, about 1% to about 15%, about 1% to about 14%, about 1% to about 13%, about 1% to about 12%, about 1% to about 11%, about 1% to about 10%, about 2% to about 20%, about 2% to about 19%, about 2% to about 18%, about 2% to about 17%, about 2% to about 16%, about 2% to about 15%, about 2% to about 14%, about 2% to about 13%, about 2% to about 12%, about 2% to about 11%, about 2% to about 10%, about 3% to about 20%, about 3% to about 19%, about 3% to about 18%, about 3% to about 17%, about 3% to about 16%, about 3% to about 15%, about 3% to about 14%, about 3% to about 13%, about 3% to about 12%, about 3% to about 11%, about 3% to about 10%, about 4% to about 20%, about 4% to about 19%, about 4% to about 18%, about 4% to about 17%, about 4% to about 16%, about 4% to about 15%, about 4% to about 14%, about 4% to about 13%, about 4% to about 12%, about 4% to about 11%, about 4% to about 10%, about 5% to about 20%, about 5% to about 19%, about 5% to about 18%, about 5% to about 17%, about 5% to about 16%, about 5% to about 15%, about 5% to about 14%, about 5% to about 13%, about 5% to about 12%, about 5% to about 11%, about 5% to about 10%, about 6% to about 20%, about 6% to about 19%, about 6% to about 18%, about 6% to about 17%, about 6% to about 16%, about 6% to about 15%, about 6% to about 14%, about 6% to about 13%, about 6% to about 12%, about 6% to about 11%, about 6% to about 10%, about 7% to about 20%, about 7% to about 19%, about 7% to about 18%, about 7% to about 17%, about 7% to about 16%, about 7% to about 15%, about 7% to about 14%, about 7% to about 13%, about 8% to about 20%, about 8% to about 19%, about 8% to about 18%, about 8% to about 17%, about 8% to about 16%, about 8% to about 15%, about 8% to about 14%, about 8% to about 13%, about 9% to about 20%, about 9% to about 19%, about 9% to about 18%, about 9% to about 17%, about 9% to about 16%, about 9% to about 15%, about 9% to about 14% or about 9% to about 13%, about 10% to about 20%, about 10% to about 19%, about 10% to about 18%, about 10% to about 17%, about 10% to about 16%, about 10% to about 15%, about 10% to about 14% or about 10% to about 13%, about 11% to about 19%, about 12% to about 18%, about 13% to about 18%, about 14% to about 18%, about 14% to about 19%, about 14% to about 17%, about 14% to about 16%, about 13% to about 16%, about 13% to about 17%, or about 14% to about 15% of the sodium percarbonate. The cleaning composition may comprise, by weight, about 1%, about 5%, about 10%, about 11%, about 12%, about 13%, about 14%, about 15%, about 16%, about 17%, about 18%, about 19%, or about 20% of the sodium percarbonate.

4. Anti-Corrosion/Etching Agent

Silicates may be included in the cleaning composition as an additive to provide for metal protection and corrosion inhibition but are additionally may provide alkalinity and additionally function as anti-redeposition agents. Exemplary silicates include, but are not limited to, sodium silicate, sodium metasilicate, sodium disilicate, potassium silicate, potassium metasilicate, potassium disilicate, and layered silicate. The cleaning composition can be provided without silicates (in other words, depending on the application, the silicate may or may not be included in the cleaning composition), but when silicates are included, they can be included in amounts that provide for desired metal protection.

The silicates can be included in the cleaning composition in an amount sufficient to provide a use solution that exhibits a rate of corrosion and/or etching of glass that is less than the rate of corrosion and/or etching of glass for an otherwise identical use solution except for the absence of the corrosion inhibitor.

Examples of silicates that can act as corrosion inhibitors include, without limitation, sodium silicates, such as those having a Na₂O:SiO₂ ratio of approximately 1:1 to approximately 1:5, respectively, and typically containing available water in the amount of from approximately 5% to approximately 25% by weight. For example, the silicates can have a Na₂O:SiO₂ ratio of about 1:1 to about 1:3.75, about 1:1.5 to about 1:3.75, or about 1:1.5 to about 1:2.5. A silicate with a Na₂O:SiO₂ ratio of approximately 1:2 and approximately 16% to approximately 22% by weight water of hydration may be used. For example, such silicates are available in powder form as GD Silicate and in granular form as Britesil H-20, available from PQ Corporation, Valley Forge, Pa. These ratios may be obtained with single silicate compositions or combinations of silicates which upon combination result in the preferred ratio.

The cleaning composition may comprise, by weight, at least about 0.5%, at least about 1%, at least about 2.5%, at least about 5%, at least about 6%, at least about 7%, at least about 7.5%, at least about 8%, at least about 9%, at least about 10%, at least about 11%, at least about 12%, at least about 12.5%, at least about 13%, or at least about 14% of the silicates. The cleaning composition may comprise, by weight, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, or less than or equal to 5% of the silicates. The cleaning composition may comprise, by weight, about 1% to about 20%, about 1% to about 19%, about 1% to about 18%, about 1% to about 17%, about 1% to about 16%, about 1% to about 15%, about 1% to about 14%, about 1% to about 13%, about 1% to about 12%, about 1% to about 11%, about 1% to about 10%, about 2% to about 20%, about 2% to about 19%, about 2% to about 18%, about 2% to about 17%, about 2% to about 16%, about 2% to about 15%, about 2% to about 14%, about 2% to about 13%, about 2% to about 12%, about 2% to about 11%, about 2% to about 10%, about 3% to about 20%, about 3% to about 19%, about 3% to about 18%, about 3% to about 17%, about 3% to about 16%, about 3% to about 15%, about 3% to about 14%, about 3% to about 13%, about 3% to about 12%, about 3% to about 11%, about 3% to about 10%, about 4% to about 20%, about 4% to about 19%, about 4% to about 18%, about 4% to about 17%, about 4% to about 16%, about 4% to about 15%, about 4% to about 14%, about 4% to about 13%, about 4% to about 12%, about 4% to about 11%, about 4% to about 10%, about 5% to about 20%, about 5% to about 19%, about 5% to about 18%, about 5% to about 17%, about 5% to about 16%, about 5% to about 15%, about 5% to about 14%, about 5% to about 13%, about 5% to about 12%, about 5% to about 11%, about 5% to about 10%, about 6% to about 20%, about 6% to about 19%, about 6% to about 18%, about 6% to about 17%, about 6% to about 16%, about 6% to about 15%, about 6% to about 14%, about 6% to about 13%, about 6% to about 12%, about 6% to about 11%, about 6% to about 10%, about 7% to about 20%, about 7% to about 19%, about 7% to about 18%, about 7% to about 17%, about 7% to about 16%, about 7% to about 15%, about 7% to about 14%, about 7% to about 13%, about 8% to about 20%, about 8% to about 19%, about 8% to about 18%, about 8% to about 17%, about 8% to about 16%, about 8% to about 15%, about 8% to about 14%, about 8% to about 13%, about 9% to about 20%, about 9% to about 19%, about 9% to about 18%, about 9% to about 17%, about 9% to about 16%, about 9% to about 15%, about 9% to about 14% or about 9% to about 13%, about 10% to about 20%, about 10% to about 19%, about 10% to about 18%, about 10% to about 17%, about 10% to about 16%, about 10% to about 15%, about 10% to about 14% about 10% to about 13%, about 8% to about 12%, about 9% to about 12%, about 10% to about 12%, about 7% to about 11%, about 8% to about 11%, about 8% to about 10%, about 9% to about 13%, about 9% to about 12% or about 9% to about 11%, or about 9% to about 10% of the silicates. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the silicates.

The cleaning composition may comprise, by weight, at least about 0.5%, at least about 1%, at least about 2.5%, at least about 5%, at least about 6%, at least about 7%, at least about 7.5%, at least about 8%, at least about 9%, at least about 10%, at least about 11%, at least about 12%, at least about 12.5%, at least about 13%, or at least about 14% of the sodium metasilicate. The cleaning composition may comprise, by weight, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, or less than or equal to 5% of the sodium metasilicate. The cleaning composition may comprise, by weight, about 1% to about 20%, about 1% to about 19%, about 1% to about 18%, about 1% to about 17%, about 1% to about 16%, about 1% to about 15%, about 1% to about 14%, about 1% to about 13%, about 1% to about 12%, about 1% to about 11%, about 1% to about 10%, about 2% to about 20%, about 2% to about 19%, about 2% to about 18%, about 2% to about 17%, about 2% to about 16%, about 2% to about 15%, about 2% to about 14%, about 2% to about 13%, about 2% to about 12%, about 2% to about 11%, about 2% to about 10%, about 3% to about 20%, about 3% to about 19%, about 3% to about 18%, about 3% to about 17%, about 3% to about 16%, about 3% to about 15%, about 3% to about 14%, about 3% to about 13%, about 3% to about 12%, about 3% to about 11%, about 3% to about 10%, about 4% to about 20%, about 4% to about 19%, about 4% to about 18%, about 4% to about 17%, about 4% to about 16%, about 4% to about 15%, about 4% to about 14%, about 4% to about 13%, about 4% to about 12%, about 4% to about 11%, about 4% to about 10%, about 5% to about 20%, about 5% to about 19%, about 5% to about 18%, about 5% to about 17%, about 5% to about 16%, about 5% to about 15%, about 5% to about 14%, about 5% to about 13%, about 5% to about 12%, about 5% to about 11%, about 5% to about 10%, about 6% to about 20%, about 6% to about 19%, about 6% to about 18%, about 6% to about 17%, about 6% to about 16%, about 6% to about 15%, about 6% to about 14%, about 6% to about 13%, about 6% to about 12%, about 6% to about 11%, about 6% to about 10%, about 7% to about 20%, about 7% to about 19%, about 7% to about 18%, about 7% to about 17%, about 7% to about 16%, about 7% to about 15%, about 7% to about 14%, about 7% to about 13%, about 8% to about 20%, about 8% to about 19%, about 8% to about 18%, about 8% to about 17%, about 8% to about 16%, about 8% to about 15%, about 8% to about 14%, about 8% to about 13%, about 9% to about 20%, about 9% to about 19%, about 9% to about 18%, about 9% to about 17%, about 9% to about 16%, about 9% to about 15%, about 9% to about 14% or about 9% to about 13%, about 10% to about 20%, about 10% to about 19%, about 10% to about 18%, about 10% to about 17%, about 10% to about 16%, about 10% to about 15%, about 10% to about 14% about 10% to about 13%, about 8% to about 12%, about 9% to about 12%, about 10% to about 12%, about 7% to about 11%, about 8% to about 11%, about 8% to about 10%, about 9% to about 13%, about 9% to about 12% or about 9% to about 11%, or about 9% to about 10% of the sodium metasilicate. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the sodium metasilicate.

5. Fillers

The cleaning composition may include a detergent filler, which does not necessarily perform as a cleaning agent per se, but may cooperate with a cleaning agent to enhance the overall cleaning capacity of the composition. Examples of suitable fillers include, but are not limited to: sodium sulfate, sodium chloride, starch, sugars, and C₁-C₁₀ alkylene glycols such as propylene glycol.

The amount of filler in the cleaning composition is such that the total amount of all components, by weight, is equal to 100%. The cleaning composition may comprise, by weight, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, or at least about 15% of the filler. The cleaning composition may comprise, by weight, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the filler.

6. Water

The cleaning composition may include water. In general, it is expected that water may be present as a processing aid and may be removed or become water of hydration. It is expected that water may be present in both the liquid concentrate and in the solid concentrate. In the case of the liquid concentrate, the water may be present in an amount, by weight, of at least about 2%, at least about 5%, at least about 7.5%, at least about 10%, or at least about 15%, at least about 20%, at least about 25%, at least about 30%, at least about 35%, at least about 40%, at least about 50%, at least about 60%, at least about 70%, at least about 75%, or at least about 80% of the cleaning composition. In the case of the liquid concentrate, the water may be present in an amount, by weight, of less than or equal to 80%, less than or equal to 75%, less than or equal to 70%, less than or equal to 60%, less than or equal to 50%, less than or equal to 40%, less than or equal to 35%, less than or equal to 30%, less than or equal to 25%, less than or equal to 20%, less than or equal to 15%, less than or equal to 10%, less than or equal to 7.5%, less than or equal to 5% or less than or equal to 2% of the cleaning composition.

In the case of a solid concentrate, the water may be present in an amount, by weight, of at least about 0.01%, at least about 0.1%, at least about 0.25%, at least about 0.5%, at least about 1%, at least about 1.25%, at least about 1.5%, at least about 1.75%, or at least about 2% of the cleaning composition. In the case of a solid concentrate, the water may be present in an amount, by weight, of less than or equal to 15%, less than or equal to 10%, less than or equal to 7.5%, less than or equal to 5%, less than or equal to 4%, less than or equal to 3%, or less than or equal to 2.5% of the cleaning composition. Water may also be present in solid compositions at less than 0.1%, less than 0.25%, less than 0.5% or less than 1%. It should be additionally appreciated that the water may be provided as deionized water or as softened water. The cleaning composition can be provided at a solids concentration that provides a desired level of detersive properties. The solids concentration refers to the concentration of the non-water components in the cleaning composition.

### 3. MANUFACTURING THE CLEANING COMPOSITION

The components used to form the cleaning composition can include an aqueous medium such as water as an aid in processing. It is expected that the aqueous medium will help provide the components with a desired viscosity for processing. In addition, it is expected that the aqueous medium may help in the solidification process when is desired to form the concentrate as a solid. When the concentrate is provided as a solid, it can be provided in the form of a block or pellet. It is expected that blocks will have a size of at least about 5 grams, and can include a size of greater than about 50 grams.

As previously discussed herein, the cleaning composition may optionally include water or the components used to form the cleaning composition can include an aqueous medium such as water as an aid in processing.

When the components that are processed to form the concentrate are processed into a pellet or block, it is expected that the components can be processed by extrusion techniques or casting techniques. In general, when the components are processed by extrusion techniques, the composition may include a relatively smaller amount of water as an aid for processing compared with the casting techniques. In general, when preparing the solid by extrusion, it is expected that the composition can contain by weight between about 2% and about 10% water. When preparing the solid by casting, it is expected that the amount of water can be provided in an amount by weight of between about 20% and about 40%. Heat can be applied from an external source to facilitate processing of the mixture.

A mixing system provides for continuous mixing of the ingredients at high shear to form a substantially homogeneous liquid or semi-solid mixture in which the ingredients are distributed throughout its mass. The mixing system includes means for mixing the ingredients to provide shear effective for maintaining the mixture at a flowable consistency, with a viscosity during processing of about 1,000-1,000,000 cP, preferably about 50,000-200,000 cP. The mixing system can be a continuous flow mixer or a single or twin screw extruder apparatus.

The mixture can be processed at a temperature to maintain the physical and chemical stability of the ingredients, such as at ambient temperatures of about 20-80° C., and about 25-55° C. Although limited external heat may be applied to the mixture, the temperature achieved by the mixture may become elevated during processing due to friction, variances in ambient conditions, and/or by an exothermic reaction between ingredients. Optionally, the temperature of the mixture may be increased, for example, at the inlets or outlets of the mixing system.

An ingredient may be in the form of a liquid or a solid such as a dry particulate, and may be added to the mixture separately or as part of a premix with another ingredient, as for example, the cleaning agent, the aqueous medium, and additional ingredients such as a second cleaning agent, a detergent adjuvant or other additive, a secondary hardening agent, and the like. One or more premixes may be added to the mixture.

The ingredients are mixed to form a substantially homogeneous consistency wherein the ingredients are distributed substantially evenly throughout the mass. The mixture can be discharged from the mixing system through a die or other shaping means. The profiled extrudate can be divided into useful sizes with a controlled mass. The extruded solid can be packaged in film. The temperature of the mixture when discharged from the mixing system can be sufficiently low to enable the mixture to be cast or extruded directly into a packaging system without first cooling the mixture. The time between extrusion discharge and packaging can be adjusted to allow the hardening of the detergent block for better handling during further processing and packaging. The mixture at the point of discharge can be about 20-90° C., and about 25-55° C. The composition can be allowed to harden to a solid form that may range from a low density, sponge-like, malleable, caulky consistency to a high density, fused solid, concrete-like block.

Optionally, heating and cooling devices may be mounted adjacent to mixing apparatus to apply or remove heat in order to obtain a desired temperature profile in the mixer. For example, an external source of heat may be applied to one or more barrel sections of the mixer, such as the ingredient inlet section, the final outlet section, and the like, to increase fluidity of the mixture during processing. Preferably, the temperature of the mixture during processing, including at the discharge port, is maintained preferably at about 20-90° C.

When processing of the ingredients is completed, the mixture may be discharged from the mixer through a discharge die. The composition eventually hardens due to the chemical reaction of the ingredients forming the E-form hydrate binder. The solidification process may last from a few minutes to about six hours, depending, for example, on the size of the cast or extruded composition, the ingredients of the composition, the temperature of the composition, and other like factors. Preferably, the cast or extruded composition “sets up” or begins to hardens to a solid form within about 1 minute to about 3 hours, preferably about 1 minute to about 2 hours, preferably about 1 minute to about 20 minutes.

As mentioned previously herein, the cleaning composition can be provided in any form known in the art, such as, for example, in liquid form, in granular form, in the form of a concentrate or in power form. When provided in the form of a concentrate, the concentrate can be provided in any form known in the art. For example, the concentrate can be in the form of a liquid. Various liquid forms include gels and pastes. Of course, when the concentrate is provided in the form of a liquid, it is not necessary to harden the composition to form a solid. In fact, it is expected that the amount of water, solvent or dispersant in the composition will be sufficient to preclude solidification. Dispersants and other components can be incorporated into the concentrate in order to maintain a desired distribution of components.

The packaging receptacle or container may be rigid or flexible, and composed of any material suitable for containing the compositions produced according to the invention, as for example glass, metal, plastic film or sheet, cardboard, cardboard composites, paper, and the like. Advantageously, since the composition is processed at or near ambient temperatures, the temperature of the processed mixture is low enough so that the mixture may be cast or extruded directly into the container or other packaging system without structurally damaging the material. As a result, a wider variety of materials may be used to manufacture the container than those used for compositions that processed and dispensed under molten conditions. Preferred packaging used to contain the compositions is manufactured from a flexible, easy opening film material.

In one embodiment, the composition of the disclosure is in unit dose form. Products in unit dose form include tablets, stamped tablets, pressed tablets, capsules, sachets, and pouches. In one embodiment, tablets, granules or powder are wrapped with a water-soluble film or pouch. In the cases of unit dose products having a water-soluble material enveloping the cleaning composition, the water-soluble material is not considered as part of the composition.

In one embodiment, the cleaning composition may be contained in a water-soluble film or pouch comprising one, two, three, or four or more compartments. Exemplary water soluble packaging films are disclosed in U.S. Pat. Nos. 6,503,879, 6,228,825, 6,303,553, 6,475,977, and 6,632,785, the entire disclosures of each of which are incorporated herein by reference in their entireties. Suitable water soluble polymers which may be used in the invention are described in Davidson and Sittig, Water Soluble Resins, Van Nostrand Reinhold Company, New York (1968), herein incorporated by reference. The water soluble polymer should have proper characteristics such as strength and pliability in order to permit machine handling. Examples of water soluble polymers include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water soluble, polyvinyl alcohol film-forming polymers are generally, preferred. Polyvinyl alcohols that can be used include those having a weight average molecular weight of between about 1,000 g/mol and about 300,000 g/mol, and between about 2,000 g/mol and about 150,000 g/mol, and between about 3,000 g/mol and about 100,000 g/mol.

The unit dose form can be a water-soluble pouch (i.e., water-soluble film enveloping a cleaning composition), such as a multi-compartment pouch having a plurality of films forming a plurality of compartments. This configuration allows for the separation and controlled release of different ingredients. Each compartment may contain a solid cleaning composition or liquid cleaning composition in any combination. In one embodiment, one compartment contains a composition in solid form and another compartment contains a composition in liquid form. If more than one compartment is present, the additional compartments may contain one or more functional agents, such as those used as a pre-wash or rinse aid, that are not considered part of the cleaning composition. Similarly if the cleaning composition is comprised in a tablet or block that contains two, three, or four layers that dissolve at different rates, the additional layers may contain one or more functional agents, such as those used as a pre-wash or rinse aid, that are not considered part of the cleaning composition.

In one embodiment, a multi-compartment pouch has two or more, or three or more different compartments having different dissolution profiles, allowing the release of the same or different compositions contained therein at different times. For example, a cleaning composition from one compartment can be delivered early in the washing process to help with soil removal and an optional detergent agent from another compartment can be delivered at least 2, at least 3, at least 4 or at least 5 minutes later than the detergent from the first compartment. A rinse aid agent may be optionally released in yet another compartment. The compartments can be side by side or superimposed (placed above one another). The pouches may contain solid or liquids in one or more of the compartments.

Controlled release of the ingredients of a multi-compartment pouch can be achieved by modifying the thickness of the film and/or the solubility of the film material. The solubility of the film material can be delayed by for example cross-linking the film. Water-soluble films designed for rinse release are described in U.S. Pat. Nos. 4,765,916 and 4,972,017. Waxy coatings, as described in WO 95/29982, of films can help with rinse release. pH controlled release means are described in WO 04/111178, in particular amino-acetylated polysaccharide having selective degree of acetylation. Other means of obtaining delayed release by multi-compartment pouches with different compartments, where the compartments are made of films having different solubility are taught in WO 02/08380. The disclosures of each of these patents or applications are incorporated herein by reference in their entireties.

### 4. USE OF THE CLEANING COMPOSITION

The cleaning composition may be used in a variety of cleaning applications. The cleaning composition may be an automatic dishwashing detergent.

The cleaning compositions can be formulated such that during use in aqueous operations, for example in aqueous cleaning operations, the wash water will have a desired pH. For example, compositions may be formulated such that during use in aqueous cleaning operations the wash water will have a pH in the range of about 5 to about 12, about 6.5 to about 12, and in some embodiments, in the range of about 7.5 to about 11. Liquid product formulations in some embodiments have a (10% dilution) pH in the range of about 7.5 to about 11.0, and in some embodiments, in the range of about 7.5 to about 9.0.

The cleaning composition may be used at a variety of pH levels. The cleaning compositions may be used in cleaning at a pH of at least about 4, at least about 5, at least about 6, at least about 7, at least about 8, at least about 9, at least about 9.5, or at least about 10. The cleaning compositions may be used in cleaning at a pH of less than or equal to 14, less than or equal to 13, less than or equal to 12, less than or equal to 11.5, less than or equal to 11, less than or equal to 10, less than or equal to 9, less than or equal to 8, less than or equal to 7, or less than or equal to 6.

The cleaning composition can be used by diluting the concentrate with water at the situs or location of use to provide the use composition. In many cases when using the cleaning composition in an automatic dishwashing or warewashing machine, the site or location of use is inside the automatic dishwashing or warewashing machine. When the cleaning composition is used in a residential or home-style dishwashing machine, the composition may be placed in the detergent compartment of the dishwashing machine. Often the detergent compartment is located in the door of the dishwashing machine. The cleaning composition can be provided in the form that allows for introduction of a single dose of the cleaning composition into the compartment. In general, single dose refers to the amount of the cleaning composition that is desired for a single warewashing application. In many commercial dishwashing or warewashing machines, and even for certain residential or home-style dishwashing machines, a large quantity of cleaning composition can be provided in a compartment that allows for the release of a portion of the composition in a single dose amount for each warewashing or dishwashing cycle. Such a compartment may be provided as part of the warewashing or dishwashing machine or it may be provided as a separate structure connected to the warewashing or dishwashing machine by a hose for delivery of liquid thereto. For example, a block, pressed tablet, stamped tablet, pouch or granules of the cleaning composition can be provided in a hopper, and water can be sprayed against the composition to provide a liquid concentrate that can be introduced into the dishwashing machine. The hopper can be a part of the dishwashing machine or it can be provided separate from the dishwashing machine.

It is expected that the water of dilution that is used to dilute the cleaning composition upon use may vary from one location to another. That is, it is expected that water available at one location may have a relatively low level of total dissolved solids while water at another location may be considered “hard.” In general, hard water is considered to be water having a total dissolved solids (TDS) content in excess of 200 ppm. The hardness of the water can effect glass corrosion. In general, water having a higher total dissolved solids content has a tendency to corrode glass quicker than water having a low level of total dissolved solids. The hardness of the water can be addressed in a number of ways. For example, the water can be softened. That is, the calcium and the magnesium can be replaced with sodium. In addition, the cleaning composition includes builders and/or optional chelating agents at levels sufficient to handle the hardness.

The cleaning composition can have a solids content that is sufficient to provide the desired level of cleaning while avoiding wasting the cleaning composition by using too much upon use. In general, it is expected that when in use the composition will have a solids content of at least about 0.025 wt %, and can have a solids content of between about 0.05 wt. % and about 0.75 wt %. The cleaning composition can be diluted with water at a dilution ratio that provides convenient use with desired detersive properties. For example, the concentrate can be diluted at a ratio of water to concentrate of at least about 20:1, and can be at between about 20:1 and about 400:1.

As mentioned previously herein, the cleaning composition of the present disclosure can be used in a variety of applications, such as, but not limited to, machine and manual warewashing (or dishwashing), presoaks, laundry and textile cleaning and destaining, carpet cleaning and destaining, vehicle cleaning and care applications, surface cleaning and destaining, kitchen and bath cleaning and destaining, floor cleaning and destaining, cleaning in place operations, general purpose cleaning and destaining, industrial or household cleaners and in toothpaste applications. The current disclosure also includes methods of cleaning various surfaces to remove dirt, oil, grease, food particles, protein residue or other debris from the surface by contacting the surface with a cleaning composition described herein. The cleaning composition may be contacted with the surface in a warewashing machine or automatic dishwashing machine. It will be understood by the skilled artisan that any surface, including, but not limited to glass, ceramic, plastic, wood and metal surfaces may be cleaned or contacted with the cleaning compositions of the current disclosure.

It will be apparent to those of skill in the art that variations may be applied to the compositions and methods described herein and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention

The present disclosure has multiple aspects, illustrated by the following non-limiting examples.

### 5. EXAMPLES

### Example 1

### Materials

Cleaning composition with a hydroxycarboxylic acid salt mixture, an oxoacid anion salt and dispersant were generated. The chemicals used herein were sourced from chemical suppliers where appropriate Anhydrous sodium carbonate, used as a pH buffering agent, was obtained from EMD Chemicals (Product #SX0395). Plurafac® SLF 180, used as a low foaming non-ionic surfactant, was obtained from BASF (Lot #0008433051). Sodium metasilicate, used as an anti-corrosion/etching agent, was obtained from Sigma Aldrich (Product #307815). Sodium percarbonate, used as a bleaching agent, was obtained from Sigma Aldrich (Product #371432). Acusol™ 445ND, a polycarboxylate dispersant, was sourced through Dow (Batch #A003C2L041). Carboxymethyl inulin, used as a dispersant, was sourced through CoSun (Batch #L11.2102.19). Polyaspartic acid, used as a dispersant, was sourced through Lanxess. The hydroxycarboxylic acid aluminum salt mixture, Riose™ detergent builder, was obtained through the oxidation of glucose at Rivertop Renewables. Oxidation of carbohydrate compounds can be carried out in a variety of known methods, including oxidation with nitric acid, oxidation with nitrogen dioxide, oxidation with air or oxygen over metal catalysts, and oxidation with tetraalkylnitroxyl radical compounds such as TEMPO.

The hydroxycarboxylic acid aluminum salt mixture described above was prepared by the nitric acid oxidation of glucose as described in U.S. Pat. Nos. 2,436,659 and 7,692,041. After removing residual nitric acid from the oxidation reaction mixture, the hydroxycarboxylic acid oxidation products were neutralized with sodium hydroxide to give the hydroxycarboxylic acid salt mixture, and then further neutralized with sodium aluminate to obtain the builder. The amounts of the major components in the builder are given in Table 2.

TABLE 2
Composition of builder

| Component | Concentration (wt %) |
|---|---|
| Disodium glucarate | 20-75 |
| Sodium gluconate | 0-10 |
| Disodium tartrate | 0-10 |
| Disodium tartronate | 0-4 |
| Sodium glycerate | 0-4 |
| Sodium glycolate | 0-4 |
| Sodium 5-ketogluconate | 0-4 |
| Sodium 2-ketogluconate | 0-2 |
| Disodium oxalate | 0-10 |
| Sodium formate | 0-10 |
| Sodium glucuronate | 0-2 |
| Sodium aluminate | 15-40 |
| Sodium nitrate | 0-7 |
| Water | 0-10 |

In order to provide a proper comparison, the same builder was used for evaluation with all the various dispersants. Table 3 contains the automatic dishwashing (ADW) cleaning composition of the formulation used for testing.

TABLE 3
ADW Detergent Composition

| Detergent Ingredient | Concentration (wt %) |
|---|---|
| Sodium Carbonate | 40% |
| Plurafac SLF 180 | 4% |
| Sodium Metasilicate | 10% |
| Sodium Percarbonate | 15% |
| Dispersant | 0-4% |
| Builder | 20% |
| Filler | to 100% |

### Example 2

### Test Methods

Each formulation as described in Examples 3 and 4 below were taken through four wash cycles each consisting of two rinse cycles, two wash cycles and a heated dry cycle. The washes were achieved at a total water hardness of 300 ppm reported as CaCO₃ (17.5 grains/gal; 2:1 Ca/Mg) and at a wash temperature of 120° F., in a Maytag automatic dishwasher (model # MDB4409PAB0). Each wash contained six clean Libbey Collins #126 high ball glasses and six plates soiled with a mixture of 80% margarine, 20% powdered milk according to ASTM Method D 3556. After these four washes were completed, all six Collins glasses were graded in an illuminating light box following the ASTM guidelines on a 1-5 filming and spotting scale, (1=completely clean and 5=completely filmed/spotted). The test methods described are summarized in Table 4 below.

TABLE 4
Test conditions for evaluating detergent performance

| | |
|---|---|
| Test method | ASTM Method D 3556 |
| Total Hardness | 300 ppm CaCO₃ (17.5 grains/gal; |
| | 2:1 Ca/Mg) |
| Automatic | Maytag Dishwasher |
| dishwasher | MDB4409PAB0 |
| Wash temperature | 120° F. |
| Detergent dose | 20 g |
| Soil load | 40 g (80% margarine/20% |
| | powdered milk) |
| Glasses | 6 Libbey Collins #126 |

### Example 3

### Comparison of Dispersant Performance

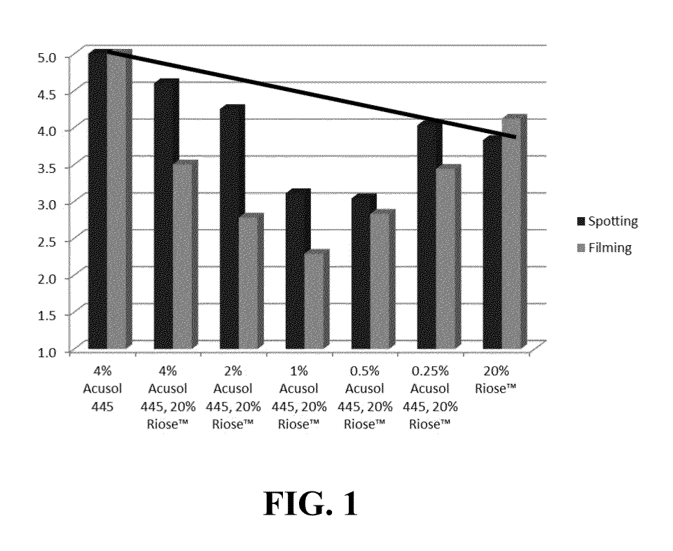

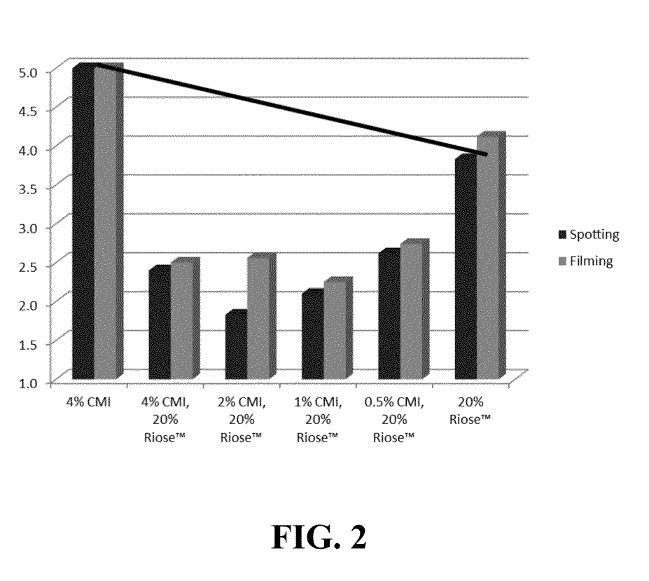

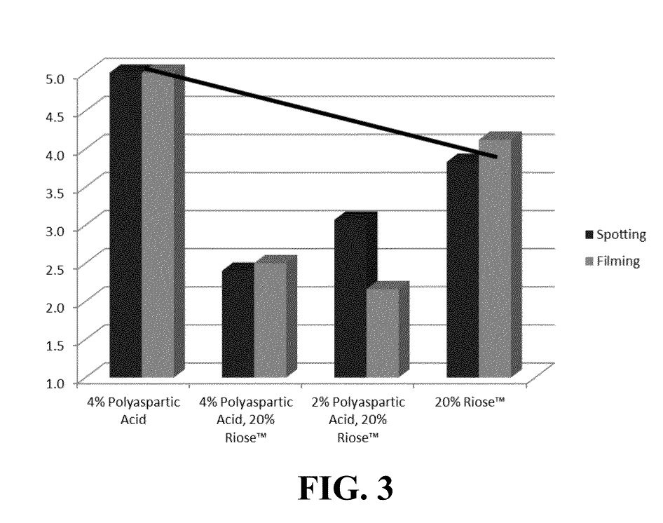

The dispersants previously disclosed in the application were employed in the formulation of Table 2 where the builder is that of Table 1 (Riose™). The resulting formulations were evaluated in the prevention of spotting and filming on glasses during automatic dishwashing. FIG. 1 shows the performance of compositions containing Acusol 445 as the dispersant, FIG. 2 shows the performance of compositions containing carboxymethyl inulin (CMI) as the dispersant, and FIG. 3 shows the performance of compositions containing polyaspartic acid (PAA) as the dispersant.

FIG. 1-3 demonstrate the extent to which each composition shows deviation from its expected, or additive, performance represented by the black lines on the graphs. Expected performance of the dispersants and builder would result in the spotting and filming scores that follow along this black line. Unexpectedly, all three dispersants and builder combinations showed better than expected performance and a synergistic improvement in automatic dishwashing (ADW) testing.

With 1% Acusol 445 employed as the dispersant, the composition showed a 47% improvement in the filming score and a 28% improvement in the spotting score over what was expected (FIG. 1 and Table 5). With 0.5% Acusol 445, the composition showed a 33% improvement in the filming score and a 29% improvement in the spotting score over what was expected. In addition, a synergistic improvement in filming performance was also observed for all other amounts of Acusol 445 added.

TABLE 5

| | | Spotting | Improvement | Filming | Improvement |
|---|---|---|---|---|---|
| | | score/ | over | score/ | over |
| | | expected | expected | expected | expected |
| Dispersant | Builder | score | score | score | score |
| 4% Acusol 445 | — | 5.0/— | — | 5.0/— | — |
| 4% Acusol 445 | 20% Riose ™ | 4.6/4.7 | 2% | 3.5/4.7 | 26% |
| 2% Acusol 445 | 20% Riose ™ | 4.25/4.5 | 6% | 2.78/4.5 | 38% |
| 1% Acusol 445 | 20% Riose ™ | 3.11/4.3 | 28% | 2.29/4.3 | 47% |
| 0.5% Acusol 445 | 20% Riose ™ | 3.04/4.2 | 28% | 2.83/4.2 | 33% |
| 0.25% Acusol 445 | 20% Riose ™ | 4.0/4.0 | 0% | 3.4/4.0 | 15% |
| — | 20% Riose ™ | 3.8/— | — | 4.1/— | — |

When carboxymethyl inulin was employed as the dispersant, a synergistic improvement in filming and spotting performance was observed for all amounts of dispersant added (FIG. 2 and Table 6), as all compositions containing carboxymethyl inulin resulted in significant improvements in the spotting and filming scores over what was expected. With 4% carboxymethyl inulin, the composition showed a 47% improvement in the filming score and a 49% improvement in the spotting score over what was expected. With 2% carboxymethyl inulin, the composition showed a 43% improvement in the filming score and a 59% improvement in the spotting score over what was expected. Even at 0.5% carboxymethyl inulin, a synergistic increase in both filming and spotting performance was seen.

TABLE 6

| | | Spotting | Improvement | | Improvement |
|---|---|---|---|---|---|
| | | score/ | over | Filming | over |
| | | expected | expected | score/expected | expected |
| Dispersant | Builder | score | score | score | score |
| 4% CMI | — | 5.0/— | — | 5.0/— | — |
| 4% CMI | 20% Riose ™ | 2.4/4.7 | 49% | 2.5/4.7 | 47% |
| 2% CMI | 20% Riose ™ | 1.83/4.5 | 59% | 2.56/4.5 | 43% |
| 1% CMI | 20% Riose ™ | 2.1/4.3 | 51% | 2.25/4.3 | 48% |
| 0.5% CMI | 20% Riose ™ | 2.6/4.0 | 35% | 2.7/4.0 | 33% |
| — | 20% Riose ™ | 3.8/— | — | 4.1/— | — |

Like carboxymethyl inulin, the employment of polyaspartic acid in the composition (FIG. 3 and Table 7) resulted in a synergistic improvement in filming and spotting performance for all amounts of dispersant added.

TABLE 7

| | | Spotting | Improvement | Filming | Improve- |
|---|---|---|---|---|---|
| | | score/ | over | score/ | ment over |
| | | expected | expected | expected | expected |
| Dispersant | Builder | score | score | score | score |
| 4% PAA | — | 5.0/— | — | 5.0/— | — |
| 4% PAA | 20% | 2.4/4.5 | 47% | 2.5/4.5 | 44% |
| | Riose ™ | | | | |
| 2% PAA | 20% | 3.1/4.1 | 24% | 2.2/4.1 | 46% |
| | Riose ™ | | | | |
| — | 20% | 3.8/— | — | 4.1/— | — |
| | Riose ™ | | | | |

### Example 4

### Comparison of Builder Performance

The dispersants identified and tested in Example 3 (PAA, CMI, Acusol 445) were then employed in compositions containing alternative builders (methylglycine diacetic acid (MGDA) and sodium citrate). For each dispersant/builder composition, 2% and 4% dispersant was used in conjunction with 20% builder.

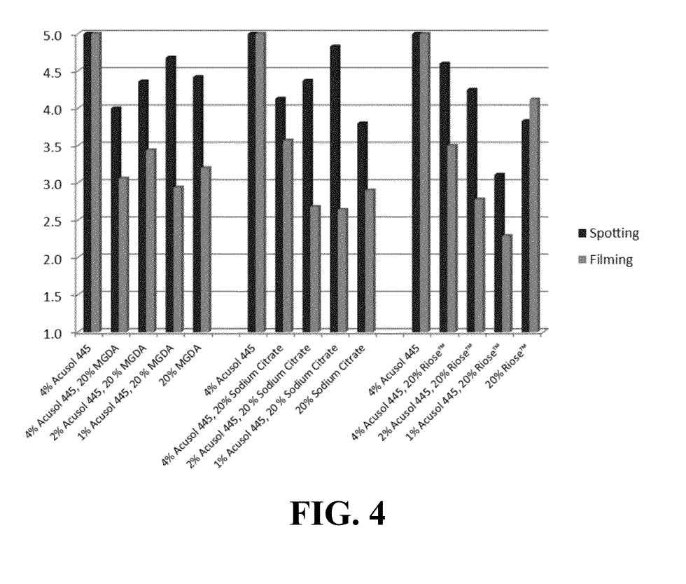

FIG. 4 displays the performance of the three builders with 1%, 2% and 4% Acusol 445. As can be seen, the formulations containing 1%, 2% and 4% Acusol 445 with 20% Riose™ showed a synergistic improvement in filming performance. However, the formulations containing Acusol 445 in combination with the other builders showed little or no synergistic improvement in spotting and filming performance.

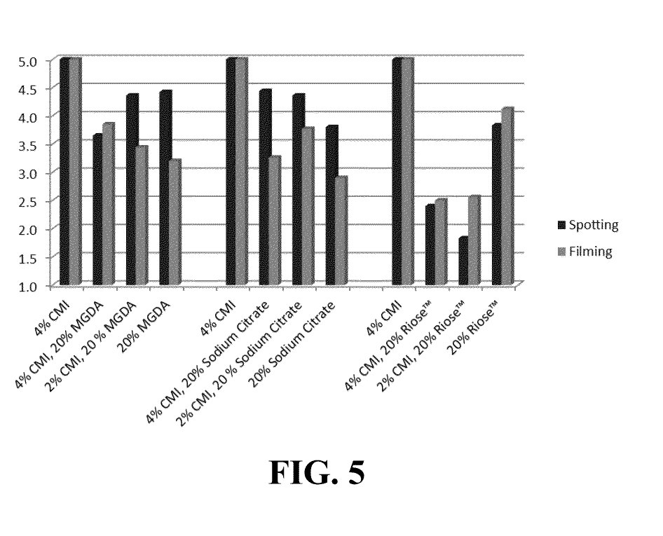

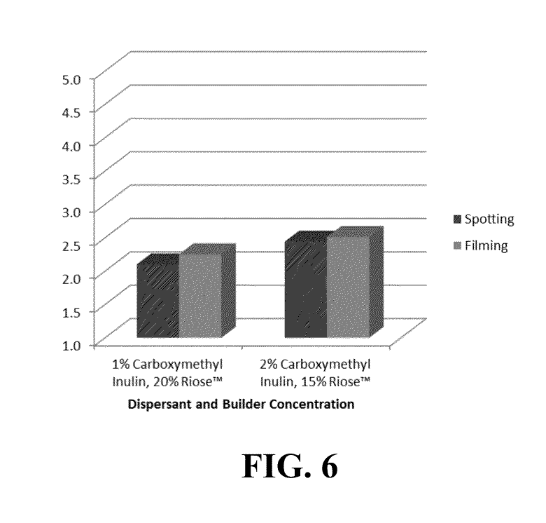

FIG. 5 displays the performance of the three builders with 2% and 4% carboxymethyl inulin. The formulations containing 2% and 4% CMI with 20% Riose™ again showed a synergistic improvement in filming and spotting performance, while the formulations containing MGDA and sodium citrate did not. The synergistic improvement in filming and spotting performance was demonstrated to be maintained between Riose™ and CMI even at significantly lower concentrations of 0.5% CMI (FIG. 6).

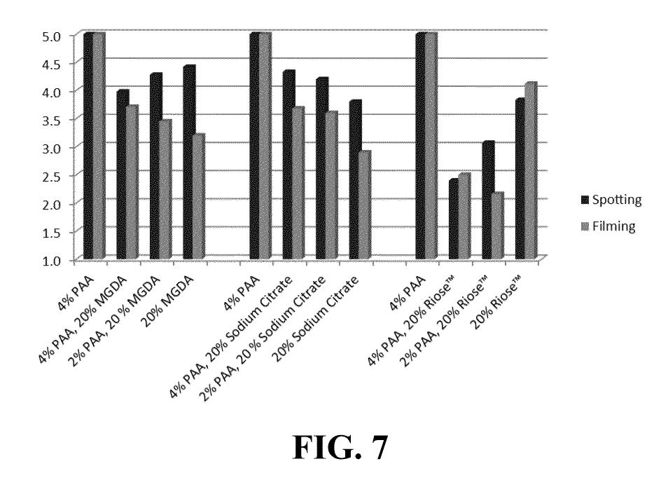

FIG. 7 displays the performance of the three builders with 2% and 4% polyaspartic acid as the dispersant. Much like the CMI formulations, the formulations containing 2% and 4% polyaspartic acid with 20% Riose™ again showed a synergistic improvement in filming and spotting performance, while the formulations containing MGDA and sodium citrate did not.

The trends observed with CMI/Riose™ and polyaspartic acid/Riose™ formulations show an unexpected and surprising improvement in performance over the comparable formulations with sodium citrate and MGDA. This positive synergy between Riose™ and the two dispersants led to a high performing ADW detergent, while substitution of other builders resulted in a poor performing detergent under all the same parameters. With Acusol 445 as the dispersant, synergistic improvement in spotting performance was observed at specific, lower concentrations of Acusol 445, while a synergistic improvement in filming performance was observed at all concentrations of Acusol 445.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the present disclosure are set out in the following numbered clauses:

Clause 1. A cleaning composition comprising, by weight, about 1% to about 45% a builder and about 0.1% to about 10% a dispersant.

Clause 2. The cleaning composition of clause 1, wherein the builder comprises: (i) at least one salt of a hydroxycarboxylic acid selected from the group consisting of hydroxymonocarboxylic acid salts, hydroxydicarboxylic acid salts and mixtures thereof; and (ii) at least one oxoacid anion salt.

Clause 3. The cleaning composition of clause 2, wherein the builder comprises, by weight, about 40% to about 90% of the at least one salt of a hydroxycarboxylic acid selected from the group consisting of hydroxymonocarboxylic acid salts, hydroxydicarboxylic acid salts and mixtures thereof, and about 10% to about 60% of the at least one oxoacid anion salt.

Clause 4. The cleaning composition of clause 3, wherein the builder further comprises, by weight, 0 to about 7% sodium nitrate, and 0 to about 10% water.

Clause 5. The cleaning composition of clause 2, wherein the at least one salt of a hydroxycarboxylic acid comprises, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, and 0 to about 2% sodium glucuronate.

Clause 6. The cleaning composition of clause 2, wherein the at least one oxoacid anion salt comprises about 15% to about 40% sodium aluminate.

Clause 7. The cleaning composition of clause 1, wherein the builder comprises, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, 0 to about 2% sodium glucuronate, about 15% to about 40% sodium aluminate, 0 to about 7% sodium nitrate, and 0 to about 10% water; wherein the total wt % does not exceed 100%.

Clause 8. The cleaning composition of clause 1, comprising, by weight, about 14% to about 22% of the builder.

Clause 9. The cleaning composition of clause 1, wherein the dispersant is carboxymethyl inulin, polyaspartic acid or a combination thereof.

Clause 10. The cleaning composition of clause 9, comprising about 0.1% to about 5% of the dispersant.

Clause 11. The cleaning composition of clause 1, wherein the dispersant is a homopolymer of acrylic acid with molecular weight of about 4500 g/mol.

Clause 12. The cleaning composition of clause 11, comprising about 0.3% to about 2% of the homopolymer of acrylic acid with molecular weight of about 4500 g/mol.

Clause 13. The cleaning composition of clause 1, further comprising sodium carbonate, sodium percarbonate, sodium metasilicate, and a low foaming non-ionic surfactant.

Clause 14. The cleaning composition of clause 13, comprising about 40% of the sodium carbonate, about 15% of the sodium percarbonate, about 10% of the sodium metasilicate, and about 4% of the low foaming non-ionic surfactant.

Clause 15. The cleaning composition of clause 1, wherein the cleaning composition has a spotting value of about 3.0 or less, as measured in accordance with ASTM D3556-85.

Clause 16. The cleaning composition of clause 1, wherein the cleaning composition has a spotting value of about 2.5 or less, as measured in accordance with ASTM D3556-85.

Clause 17. The cleaning composition of clause 1, wherein the cleaning composition has a filming value of less about 3.0 or less, as measured in accordance with ASTM D3556-85.

Clause 18. The cleaning composition of clause 1, wherein the cleaning composition has a filming value of about 2.5 or less, as measured in accordance with ASTM D3556-85.

Clause 19. The cleaning composition of clause 1, wherein the spotting value is at least 2.0 less than the spotting value of a cleaning composition comprising no builder, as measured in accordance with ASTM D3556-85.

Clause 20. The cleaning composition of clause 1, wherein the spotting value is at least 0.5 less than the spotting value of a cleaning composition comprising no dispersant, as measured in accordance with ASTM D3556-85.

Clause 21. The cleaning composition of clause 1, wherein the spotting value is at least 2.0 less than the spotting value of a cleaning composition comprising no builder; and wherein the spotting value is at least 0.5 less than the spotting value of a cleaning composition comprising no dispersant, as measured in accordance with ASTM D3556-85.

Clause 22. The cleaning composition of clause 1, wherein the cleaning composition is an automatic dishwashing detergent.

Clause 23. A cleaning composition selected from the group consisting of:

a cleaning composition comprising, by weight, about 20% of a builder and about 4% carboxymethyl inulin;

a cleaning composition comprising, by weight, about 20% of a builder and about 2% carboxymethyl inulin;

a cleaning composition comprising, by weight, about 20% of a builder and about 1% carboxymethyl inulin;

a cleaning composition comprising, by weight, about 20% of a builder and about 0.5% carboxymethyl inulin;

a cleaning composition comprising, by weight, about 15% of a builder and about 2% carboxymethyl inulin;

a cleaning composition comprising, by weight, about 20% of a builder and about 4% polyaspartic acid;

a cleaning composition comprising, by weight, about 20% of a builder and about 2% polyaspartic acid;

a cleaning composition comprising, by weight, about 20% of a builder and about 1% a homopolymer of acrylic acid with molecular weight of about 4500 g/mol; and a cleaning composition comprising, by weight, about 20% of a builder and about 0.5% a homopolymer of acrylic acid with molecular weight of about 4500 g/mol;

wherein the builder is a mixture comprising, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, 0 to about 2% sodium glucuronate, about 15% to about 40% sodium aluminate, 0 to about 7% sodium nitrate, and 0 to about 10% water.

Clause 24. A method of cleaning a surface comprising contacting the surface with the cleaning composition of clause 1.

Clause 25. The method of clause 24, wherein the surface is contacted with water.

Clause 26. The method of clause 24, wherein the surface comprises ceramic, glass or metal.

What is claimed is:

1. A cleaning composition comprising, by weight, about 1% to about 45% a builder and about 0.1% to about 10% a dispersant.

2. The cleaning composition of claim 1, wherein the builder comprises
(i) at least one salt of a hydroxycarboxylic acid selected from the group consisting of hydroxymonocarboxylic acid salts, hydroxydicarboxylic acid salts and mixtures thereof; and
(ii) at least one oxoacid anion salt.

3. The cleaning composition of claim 2, wherein the builder comprises, by weight, about 40% to about 90% of the at least one salt of a hydroxycarboxylic acid selected from the group consisting of hydroxymonocarboxylic acid salts, hydroxydicarboxylic acid salts and mixtures thereof, and about 10% to about 60% of the at least one oxoacid anion salt.

4. The cleaning composition of claim 3, wherein the builder further comprises, by weight, 0 to about 7% sodium nitrate, and 0 to about 10% water.

5. The cleaning composition of claim 2, wherein the at least one salt of a hydroxycarboxylic acid comprises, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, and 0 to about 2% sodium glucuronate.

6. The cleaning composition of claim 2, wherein the at least one oxoacid anion salt comprises about 15% to about 40% sodium aluminate.

7. The cleaning composition of claim 1, wherein the builder comprises, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, 0 to about 2% sodium glucuronate, about 15% to about 40% sodium aluminate, 0 to about 7% sodium nitrate, and 0 to about 10% water; wherein the total wt % does not exceed 100%.

8. The cleaning composition of claim 1, comprising, by weight, about 14% to about 22% of the builder.

9. The cleaning composition of claim 1, wherein the dispersant is carboxymethyl inulin, polyaspartic acid or a combination thereof.

10. The cleaning composition of claim 9, comprising about 0.1% to about 5% of the dispersant.

11. The cleaning composition of claim 1, wherein the dispersant is a homopolymer of acrylic acid with molecular weight of about 4500 g/mol.

12. The cleaning composition of claim 11, comprising about 0.3% to about 2% of the homopolymer of acrylic acid with molecular weight of about 4500 g/mol.

13. The cleaning composition of claim 1, further comprising sodium carbonate, sodium percarbonate, sodium metasilicate, and a low foaming non-ionic surfactant.

14. The cleaning composition of claim 13, comprising about 40% of the sodium carbonate, about 15% of the sodium percarbonate, about 10% of the sodium metasilicate, and about 4% of the low foaming non-ionic surfactant.

15. The cleaning composition of claim 1, wherein the cleaning composition has a spotting value of about 3.0 or less, as measured in accordance with ASTM D3556-85.

16. The cleaning composition of claim 1, wherein the cleaning composition has a spotting value of about 2.5 or less, as measured in accordance with ASTM D3556-85.

17. The cleaning composition of claim 1, wherein the cleaning composition has a filming value of less about 3.0 or less, as measured in accordance with ASTM D3556-85.

18. The cleaning composition of claim 1, wherein the cleaning composition has a filming value of about 2.5 or less, as measured in accordance with ASTM D3556-85.

19. The cleaning composition of claim 1, wherein the spotting value is at least 2.0 less than the spotting value of a cleaning composition comprising no builder, as measured in accordance with ASTM D3556-85.

20. The cleaning composition of claim 1, wherein the spotting value is at least 0.5 less than the spotting value of a cleaning composition comprising no dispersant, as measured in accordance with ASTM D3556-85.

21. The cleaning composition of claim 1, wherein the spotting value is at least 2.0 less than the spotting value of a cleaning composition comprising no builder; and wherein the spotting value is at least 0.5 less than the spotting value of a cleaning composition comprising no dispersant, as measured in accordance with ASTM D3556-85.

22. The cleaning composition of claim 1, wherein the cleaning composition is an automatic dishwashing detergent.

23. A cleaning composition selected from the group consisting of:
a cleaning composition comprising, by weight, about 20% of a builder and about 4% carboxymethyl inulin;
a cleaning composition comprising, by weight, about 20% of a builder and about 2% carboxymethyl inulin;
a cleaning composition comprising, by weight, about 20% of a builder and about 1% carboxymethyl inulin;
a cleaning composition comprising, by weight, about 20% of a builder and about 0.5% carboxymethyl inulin;
a cleaning composition comprising, by weight, about 15% of a builder and about 2% carboxymethyl inulin;
a cleaning composition comprising, by weight, about 20% of a builder and about 4% polyaspartic acid;
a cleaning composition comprising, by weight, about 20% of a builder and about 2% polyaspartic acid;
a cleaning composition comprising, by weight, about 20% of a builder and about 1% a homopolymer of acrylic acid with molecular weight of about 4500 g/mol; and
a cleaning composition comprising, by weight, about 20% of a builder and about 0.5% a homopolymer of acrylic acid with molecular weight of about 4500 g/mol;
wherein the builder is a mixture comprising, by weight, about 20% to about 75% disodium glucarate, 0 to about 10% sodium gluconate, 0 to about 10% disodium tartrate, 0 to about 4% disodium tartronate, 0 to about 4% sodium glycerate, 0 to about 4% sodium glycolate, 0 to about 4% sodium 5-ketogluconate, 0 to about 2% sodium 2-ketogluconate, 0 to about 10% disodium oxalate, 0 to about 10% sodium formate, 0 to about 2% sodium glucuronate, about 15% to about 40% sodium aluminate, 0 to about 7% sodium nitrate, and 0 to about 10% water.

24. A method of cleaning a surface comprising contacting the surface with the cleaning composition of claim 1.

25. The method of claim 24, wherein the surface is contacted with water.

26. The method of claim 24, wherein the surface comprises ceramic, glass or metal.
